(19) United States
(12) Patent Application Publication
(10) Pub. No.: US 2005/0091025 A1
(43) Pub. Date: Apr. 28, 2005

(54) Methods and systems for improved integrated circuit functional simulation

(76) Inventors: James C. Wilson, Los Gatos, CA (US); Kenneth W. Imboden, San Jose, CA (US); David Gold, Santa Fe, NM (US)

Correspondence Address: PILLSBURY WINTHROP LLP, 2475 HANOVER STREET, PALO ALTO, CA, 94304-1114, US

(21) Appl. No.: 10/927,810

(22) Filed: Aug. 26, 2004

Related U.S. Application Data
(60) Provisional application No. 60/498,133, filed on Aug. 26, 2003.

(51) Int. Cl. G06F 17/50

(52) U.S. Cl. 703/16

(57) ABSTRACT

Methods and systems for performing symbolic simulation, including techniques for translating a conventional simulation into a symbolic simulation, for handling wait and delay states, and for performing temporally out-of-order simulations. Additional techniques for extracting a signal graph from an HDL representation of a device, for representing signal values as functions of time using binary decision diagrams, and for computing minimal signal sets for accurate simulation. Techniques and methods for improving waveform dumping, reducing the waveform database, and for combining out-of-order simulation or reduced time steps with conventional time-based simulation.

### BACKGROUND

1. Field of the Invention

This invention relates generally to systems and methods for simulating the functionality of digital semiconductor-based integrated circuits. More specifically, the present invention is directed to systems, methods and techniques for implementing simulation algorithms.

2. Background of the Invention

Verifying the functionality of integrated circuits (ICs) prior to fabrication is a common practice due to the high cost associated with building ICs. Modern IC designs are typically verified using simulation. Simulation is the process of creating a model of the design, writing a test which applies stimulus to the model, running the stimulus on the model, and then checking that the model's output matches the expected behavior based on the stimulus. The stimulus is often called a test. The model and test are represented using code which defines a set of signals and operations to be performed upon each signal over time. The simulator will output a value for each signal at every time step defined by the test.

Many forms of code have been used in the prior art to represent models and stimulus. One common form is a hardware description language (HDL) such as Verilog or VHDL. In such an approach, the function of each signal is described in HDL as a set of assignments of expressions to the signal. In the actual hardware, all of the functions implementing the design work in parallel, independently of each other. However, simulation is normally performed on a computer that operates serially, which performs operations one at a time in sequential order. A given HDL defines semantic rules that maintain an illusion of parallelism in the simulated hardware.

In conventional simulation products, the basic algorithm for simulation is as follows:

Read in model and test.
Initialize all signals to their initial value.
For each time step t from 0 to last_time_step {
For each signal s in the model and test {
Compute the value of s for time step t;
}
}

Stated differently, conventional binary simulation consists of a design plus test case written in a hardware description language such as Verilog. Conventional test cases consist of code that injects values into the design over a simulated time period and then checks that the design generates the correct output.

Because of the serial nature of the simulation algorithm, a simulation is usually substantially slower than the actual hardware. For example, a modem microprocessor may operate at 1 GHz (1 billion cycles per second), but a simulation of that microprocessor may only run at 1 Hz (1 cycle per second). To put this in perspective, one second of operation of the microprocessor running at 1 GHz would require over 30 years simulation time to run the equivalent number of cycles. This large gap in speed forces designers to be very careful in writing tests to ensure that each cycle of simulation verifies as much functionality as possible. The result of slow simulation is: 1) a high degree of effort required in designing tests, and 2) insufficient verification of all the functionality of a design.

Simulation speed, then, is a crucial factor in the success of verification. Many methods of improving simulation performance have been devised. These can generally be classified into one of three types:
Methods for reducing the amount of overhead required in updating each signal at each time step.
Methods for reducing the size of the model before simulation.
Methods for performing signal updates to independent signals in parallel using multiple processors.

Symbolic simulation is a method that provides speedup for a computation when there is parallelism present in the problem. Prior art simulators have used symbolic simulation only to speedup aspects of simulation that can be determined statically, that is, before simulation starts. What has been needed is a technique which will permit extracting and exploiting additional parallelism, including that which can only be determined dynamically.

### SUMMARY OF THE INVENTION

The present invention provides an efficient, effective method for implementing symbolic simulation of complex hardware devices. Various aspects of the invention provide for extraction of the necessary signals from the binary representation of the device, representation of signal values as functions of time using a binary decision diagram (hereinafter sometimes referred to as a “BDD”), development of minimal signal sets, and development of temporally out of order simulation.

Other aspects of the invention provide for reductions in the number of time steps required for simulation, methods for waveform dumping, and for combining symbolic simulation techniques with conventional binary simulations. Such combinations may include, for example, reductions in the number of time steps to be simulated, or development of a combined signal set.

The foregoing aspects of the invention will be better understood from the following Detailed Description of the Invention, taken together with the appended Figures, summarized below.

### FIGURES

FIG. 1A shows in source code form an example of binary to symbolic simulation conversion.

FIG. 1B shows in diagrammatic form a signal dependency graph for the binary to symbolic simulation conversion of FIG. 1 A.

FIGS. 1C-1F show in table form exemplary signal values at various time steps for the conversion of FIG. 1A.

FIG. 2 shows in flow diagram form an example of a Signal Extraction process, where data is characterized by rectangles and process steps are characterized by ellipses.

FIG. 3 shows in source code form an example of a hardware description language description of a test.

FIG. 4 shows in flow diagram form an exemplary version of an event graph.

FIG. 5 shows in flow diagram form an exemplary version of a “Scheduled Event” graph.

FIGS. 6A-6B show in flow diagram form a trigger pre-allocation for a vertex with a back-edge, where FIG. 6A shows the error condition and FIG. 6B shows the correct condition.

FIG. 7A shows in table form various signal definitions.

FIGS. 7B-7D show in exemplary form various extracted signal graph expressions for the signals defined in FIG. 7A.

FIG. 8A shows in table form the variation of the exemplary signals “clock” and “count” over time.

FIG. 8B shows an exemplary BDD representation of the exemplary signals of FIG. 8A.

FIGS. 9A-9F show exemplary forms of the computation of a minimal signal set.

FIGS. 10A-10D show a simulation performed in parallel across time steps using an unrolled function, or what may be thought of as temporally out-of-order simulation.

### DETAILED DESCRIPTION OF THE INVENTION

Converting Binary Simulation into Symbolic Simulation

One aspect of the current invention is an automated way to convert aspects of a conventional simulation problem into a symbolic simulation problem that are not convertible using prior art methods. The present invention describes methods for extracting and exploiting additional parallelism that can only be determined dynamically. This is beneficial because it allows further speedup of simulation by exploiting parallelism that could not be exploited by prior art methods.

Because hardware is inherently highly parallel, there are many aspects of the conventional simulation problem that can be parallelized in accordance with the present invention. In particular, the following categories of simulation may be parallelized in appropriate circumstances:
Tests—normally many tests are written for a design, each independent of the other. Therefore it is possible to simulate multiple tests in parallel.
Structure—independent structures can be simulated in parallel.
Events—The simulation process is broken down into a series of events that simulates the action of a single component at a given time step. Events that do no affect each other can be simulated in parallel.
Time—Simulation usually occurs over a number of simulated time steps. Each signal within the simulation must have a value computed at each time step. If the value of a signal at each time step is independent of values at other time steps, simulation across different time steps can be done in parallel. For example, combinational logic, which constitutes the majority of operations in hardware, is time independent allowing combinational signals to be computed in parallel across time if the inputs to the combinational functions are available for all time.

Parallelization is beneficial because it allows faster computation by performing operations in parallel. Methods that have been used to exploit parallelism in simulation are:
Multiple processors—dividing work up on multiple processors is an obvious way of exploiting parallelism.
Mapping to field programmable gate arrays (FPGA)—since simulation models correspond to hardware, it is straightforward to convert the simulation model into a FPGA. This is a form of structural parallelism since structures in the simulation model map to structures in the FPGA that run in parallel.
Symbolic simulation—symbolic simulation is similar to conventional simulation, but allows aspects of the simulation that are parallelizable to be encoded as symbols. Each symbol represents one of two possibilities. As many symbols as are necessary are created to represent the set of parallelizable operations. For example, four possible combinations can be represented using two binary variables.

The present invention describes methods for:
uncovering parallelism that can only be determined dynamically,
encoding this parallelism as a symbolic simulation problem,
using symbolic simulation to simulate the dynamic aspects of the conventional simulation problem.

In one exemplary arrangement, parallelism across time (temporal parallelism) is discovered and then exploited using symbolic simulation. One method for implementing this is to:
use an out-of-order simulation algorithm to expose temporal parallelism.
Represent time symbolically and store signal values as a function of time using BDDs, or what may be thought of as compact representation.
Perform BDD-based symbolic simulation over the exposed parallelizable operations by performing symbolic operations over the input signal time histories represented as BDDs to produce an output BDD representing the computed signal's values over all time steps.

Exemplary arrangements for each of these steps is described in detail below.

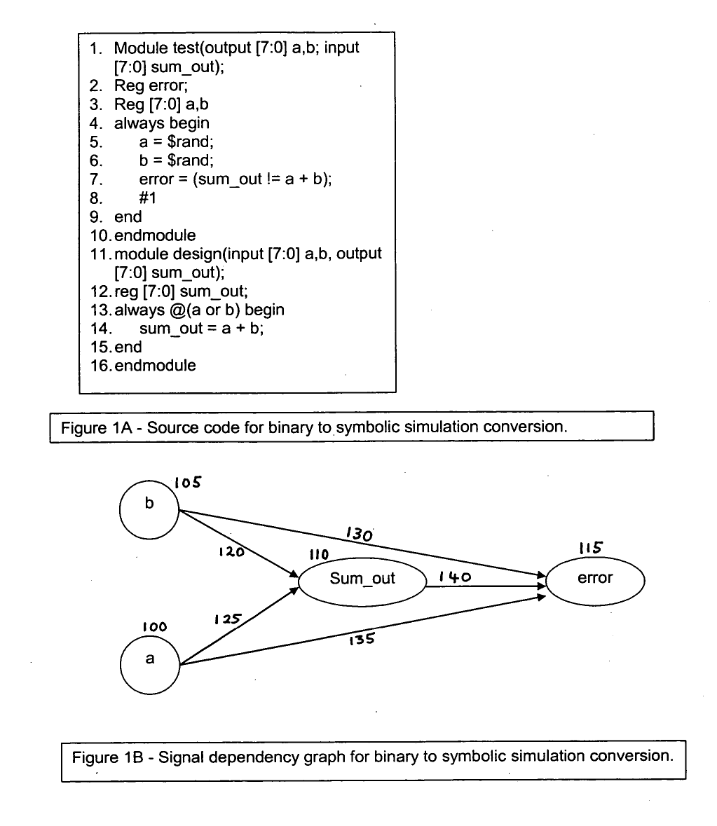

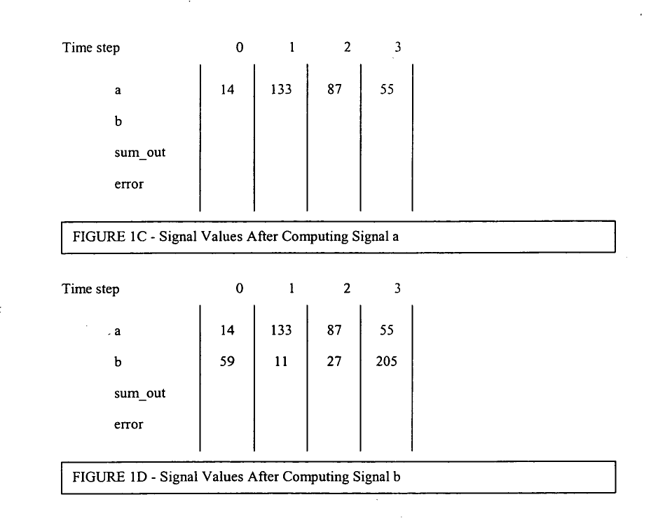

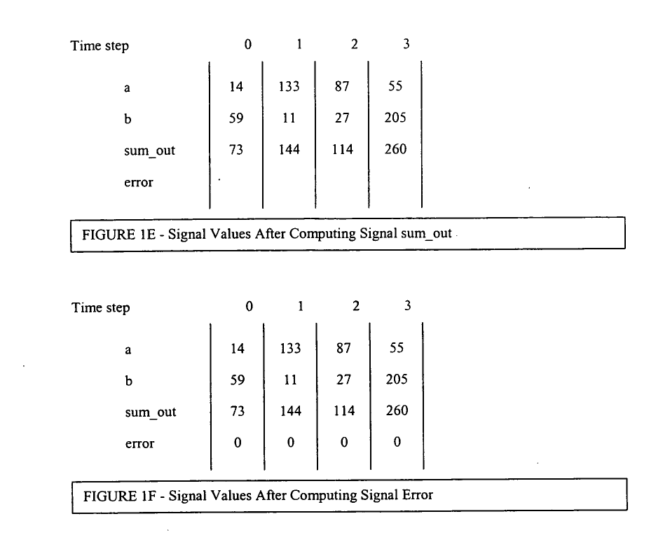

Out-of-order simulation allows some signals to be simulated across multiple time steps before other signals are simulated. As one example, assume the design comprises an adder and the test performs a series of adds in successive time steps. FIG. 1A gives the source for the test and design in Verilog format.

Lines 1-10 are the test case code. Lines 2-3 declare signals used in the test. Lines 4-9 generate a new test at each time step. Lines 5 and 6 generate random values for inputs “a” and “b” respectively. Line 6 checks that the result of the add that the design produces (sum_out) is equal to the correct value, which is the sum of the values “a” and “b”. Note that at each time step, “a” and “b” will be a different and independent pair of values for every time step. Line 8 advances time after one pair of test values are generated and checked. Lines 11-16 are the design under test. The design has inputs “a”, “b”, and output “sum_out”. Note that the test has the same set of signals, but “a” and “b” are outputs and “sum_out” is an input as specified in line 1. Lines 13-15 cause an add to be done of “a” and “b” whenever the values of “a” or “b” change. The result is put in “sum_out”.

As described hereinafter in connection with out-of-order simulation, an aspect of the present invention performs the following steps:
compute a signal dependency graph specifying which signals a signal is dependent on (is a function of).

Compute the strongly connected components (SCC) of the dependency graph.

Compute the component graph for the dependency graph.

Processing each SCC in component graph order,

Simulate the signals in each SCC for all time steps before simulating any signals in the next SCC.

The dependency graph for the source code in FIG. 1A is shown in FIG. 1B. In the graph, there is a vertex for each signal, labeled “a”, “b”, “sum_out”, and “error” and shown as 100, 105, 110 and 115, respectively. Directed edges between vertices indicate that one signal is a function of another. Signals “a” and “b” are generated using the $rand function (FIG. 1A) which simply returns a random number, therefore these signals are not dependent on any other signal and, so, do not have any incoming edges. Signal “sum_out” is a function of “a” and “b” so there is an edge 120 from “a” to “sum_out” and another edge 125 from “b” to “sum_out”. Signal “error” is a function of “a”, “b”, and “sum_out”, therefore there is an edge 130 from “a” to “error”, an edge 135 from “b” to “error”, and an edge 140 from “sum_out” to “error”.

In this example, there are no vertices in the dependency graph that have outgoing edges that lead back to the same vertex, either directly or indirectly. Therefore, the SCCs of the graph are just the vertices of the graph and the component graph is the same as the dependency graph. The SCCs and, therefore, the dependency graph vertices are processed in dependency order. That is, vertices that are needed by other vertices are processed first. In the example of FIG. 1 B, the order is:

“a”

“b”

“sum_out”

“error”

Each signal is simulated for all time steps in this order before moving on to the next signal. First the values for “a” are generated by selecting a random value for “a” at each time step. FIG. 1C illustrates simulation progress after simulating signal “a” and shows simulation for four time steps, labeled 0 to 3 in the figure. A vertical bar delineates each time step. The value for signal “a” is shown at each time step on the line labeled “a”. The other signal values, labeled “b”, “sum_out”, and “error” in FIG. 1C are shown with no values filled in for any time step indicating that these signals have not been simulated yet. FIG. 1D shows the results after simulating signal “b” for all time steps. The values for signal “b” are also generated randomly at each time step. The values for signal “b” are filled in as indicated on the line labeled “b”, indicating that signal “b” has completed simulation.

The next step is to compute the value of “sum_out” for all time steps. In accordance with the present invention, this is detected as being a parallelizable computation because the dependent signals for “sum_out” are not in the same SCC as “sum_out”. The simulator, therefore, knows that the values of “a” and “b” are available for all time steps since they must have been computed for all time steps already. In accordance with the present invention, the value histories for signals “a” and “b” for all time steps are stored in a compact fashion. In one embodiment, this can be a binary decision diagram (BDD) as described herein. The simulator can, therefore, compute the value of “sum_out” in parallel across all time steps since the values of its dependent signal inputs are known for all time and are available. In one embodiment, this is done using BDD-based symbolic simulation.

A BDD is a directed acyclic graph with two types of vertices: terminals and non-terminals. Terminals are labeled with a constant value and have no outgoing edges. Non-terminals represent functions and are labeled with a Boolean variable and have two outgoing edges. A non-terminal with label x and its left edge pointing to vertex f and its right edge to vertex g represents the function h(x)=□x & f|x & g, where □, &, and | are standard Boolean NOT, AND, and OR operators. In some embodiments in which the simulator tries to detect temporal parallelism, BDD variables consist of indices of the bit vector that represents time. For example, if the range of time steps being simulated is 0-3, then time can be represented using a two bit vector of BDD variables where the value of the bit vector representing time step 2, for example, is bit1=1 and bit0=0.

Given two BDDs representing the values of “a” and “b” for all time, symbolic simulation computes the value of “sum_out” for all time. In accordance with the present invention, symbolic simulation treats BDDs the same way a conventional binary simulator treats numeric constants. For example, in binary simulation, given the assignment “sum_out =a+b”, the simulator would fetch values for “a” (2, for example) and “b” (2, for example), and sum them to generate the value 4 for “sum_out”. Symbolic simulation operates in a somewhat similar manner, but fetches BDDs instead of numeric constants and performs a symbolic add; using algorithms.

The result of performing the symbolic simulation of “sum_out” is a BDD representing the values of “sum_out” for all time steps. The BDD contains the value of “sum_out” for each simulated time step. FIG. 1E shows the results after completing this step of the simulation. The value of “a” and “b” are given on the lines labeled “a” and “b” respectively. The value of “sum_out” corresponding to the BDD that was computed by the symbolic simulation is given in the line labeled “sum_out”. For each time step, it can be seen that it is equal to the sum of “a” and “b” at that time step.

The next step is to compute the value of “error” for all time steps. Since its dependent inputs, “a”, “b”, and “sum_out” all are generated in other SCCs, the simulator detects that this signal also can be simulated in parallel over all time steps using symbolic simulated as described above. The result of this step is shown in FIG. 1F which shows that the value of “error” is 0 for all time steps as expected on the line labeled “error” in the diagram. At this point, the value of all signals has been computed for all time steps so the simulation is complete.

The above example demonstrates that the present invention is able to extract parallelism dynamically during simulation. It is also able to exploit this by encoding the temporal parallelism as a symbolic simulation problem by using BDDs to compactly represent signal time histories and then performing the operations specified by the source code to produce the value for the simulated signal. These operations are carried out using standard BDD algorithms to achieve faster simulation due to the speedup of symbolic simulation on parallelizable problems. Prior art methods are not capable of detecting and taking advantage of parallelism dynamically. Consequently, the present invention is beneficial because it allows further speedup of simulation by using symbolic simulation to exploit parallelism that could not be exploited by prior art methods.

Extracting a Signal Graph from Source Code

A hardware description language (HDL) is used to describe a device, which may be simulated or synthesized for manufacture. Hardware descriptions consist of a set of signals and operations performed on them as a function of other signals. HDLs also include constructs for writing tests for the design being described.

The device model is usually written in a restricted form of HDL called register transfer level (RTL). The RTL subset is defined such that code written in the RTL subset is easily mappable to hardware, a process that is called synthesis. HDL code may contain multiple assignments to the same signal. A property of hardware is that each signal is the result of a single assignment. Therefore, one of the main functions of the synthesis process is to gather multiple assignments into a single assignment that performs the same function as the multiple assignments. Prior art synthesis tools assume an implicit clock which defines the advancement of time. Test cases have explicit delays and waits, which define the advancement of time explicitly. Therefore, prior art methods do not allow test cases to be synthesized.

An aspect of the present invention describes methods for combining multiple assignments when the source code contains explicit delays or waits. This is beneficial in a synthesis context because it allows a larger subset of the HDL to be synthesizable. In a simulation context, it is beneficial when using simulation methods that require multiple assignments to be combined into a single assignment for both the test case and the RTL description of the design, as exemplified by the method described hereinafter in connection with out-of-order simulation.

One important feature of this aspect of the present invention is based on the concept of a trigger. Some HDLs, such as Verilog, are defined in terms of events. An event is an assignment to a signal at a particular time step. A trigger is a function that specifies at which time steps a specific event occurs. In accordance with the present invention, trigger functions are defined as follows:
Every assignment has an associated trigger.
A trigger is a function which returns the value true if the assignment is put on the event queue at a given time step and false otherwise.
Assignments have semantics as follows: if the trigger associated with an assignment is true at a given time step, then the signal takes the value computed by the assignment at that time step, else it retains its current value.
Multiple assignments are combined by specifying a set of triggers in priority order. Semantically, if the highest priority trigger function is true for a given signal, the highest priority assignment is performed. Otherwise, the next highest priority trigger is checked, and so forth. If no triggers are true at a given time step, then the signal value does not change, that is, it retains the value from the previous time step.

Prior art methods of combining assignments assume an implied global trigger. By contrast, the present invention explicitly creates signals to represent the value of each trigger. In particular, the present invention:
Associates a trigger function with every assignment.
Allows an arbitrary number of trigger functions to be created.
Allows each assignment to have any possible trigger function defined by the semantics of the HDL instead of a single implied trigger.
Allows multiple assignments that are affected by waits and delays to be combined into a single assignment.

During simulation, an event may be added and removed from an event queue multiple times in a single time step. A limitation which occurs in certain embodiments of the current invention is that events are assumed to be added and removed at most once per time step or, if added multiple times, the additional events do not change the value of the signal. RTL and most test benches obey this limitation, so this is generally not an issue.

In some embodiments of the present invention, the output of this process is a signal graph. A signal graph is a representation of the HDL description in which each vertex represents a signal, each vertex is annotated with the set of combined assignments to the signal, and each edge represents a dependency between two signals. Signal extraction is a process that takes HDL source code and produces a signal graph.

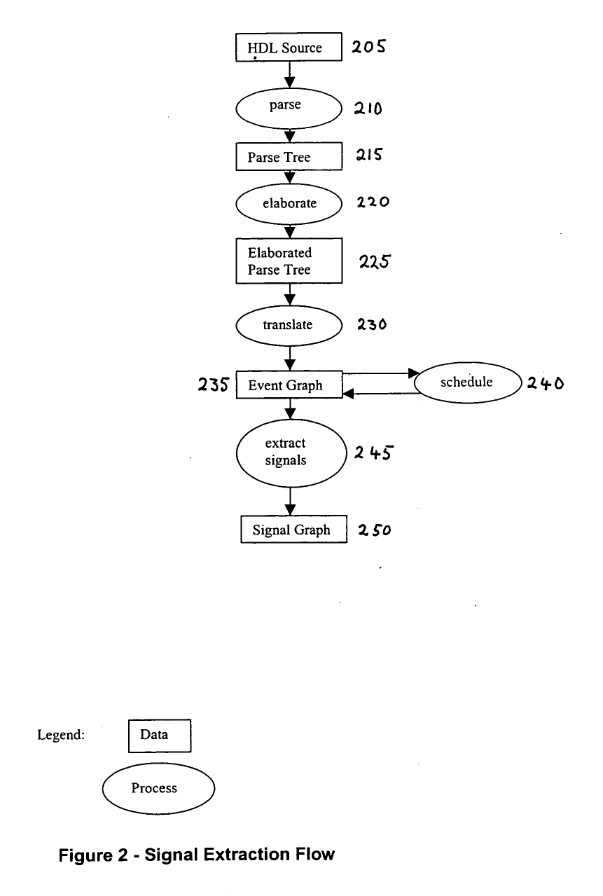

With reference generally to FIG. 2, the basic steps in an exemplary signal extraction process are shown. It will be appreciated that, in FIG. 2, process steps are shown in ellipses, while data is shown in rectangles. The basic steps in the example of FIG. 2 are, beginning with the HDL source as indicated at 205:
Parse (210 ) the HDL source code description to create a Parse Tree (215 ); then elaborate the Parse Tree (at 220) to create an Elaborated Parse Tree (225), which can be translated (230) into an event graph (235).
Schedule the vertices of the event graph, as shown at 240
Annotate each event graph vertex with a trigger function according to the semantics of the HDL and combine multiple assignments to the same target signal into one assignment, according to the semantics of the HDL, as shown at 245, resulting in the signal graph shown at 250.

Each of these steps is described in the following sections.

Creating the Event Graph

An event graph is a model of the design that represents the parsed and elaborated source code. The event graph is a directed graph that comprises heterogeneous vertices and edges representing the signals and structures of the design, and the relationships between them. Each vertex contains an expression, possibly nil, the interpretation of which depends on the vertex type.

One embodiment of the present invention uses an event graph with the following vertex types to represent HDL descriptions written in the Verilog language:
initial—a vertex from which all other vertices are reached.
head-of-block—a vertex that represents the head of a procedural block of the design description, e.g., an initial or always block in Verilog.
end of block—represents the end of a procedural block.
assignment—represents an assignment of an expression to a target signal.
expression—represents a test and branch, such as that resulting from an if-then-else in the source description.
wait—represents an event control, a point where control flow should wait pending occurrence of the specified event.
delay—represents a fixed delay; control flow should wait pending the elapse of the specified number of time units.
and the edge types:
sequential trigger—represents sequential flow between one vertex and the next, such as that between two consecutive statements in a Verilog always block. For expression-type vertices, each outgoing sequential trigger edge is labeled with a Boolean value, true or false, to indicate which edge(s) should be followed depending on the truth value of the expression contained within the vertex.
signal change sensitivity—represents the sensitivity of a vertex to a change in the value of a signal s made by another vertex. An edge (u,v) indicates that vertex u assigns to a particular signal and that the action at vertex v must be performed if the value of signal s changes as a result of the assignment at vertex u.

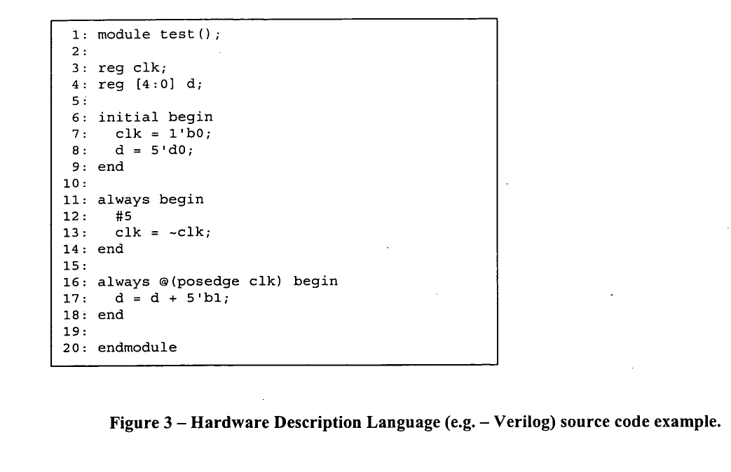

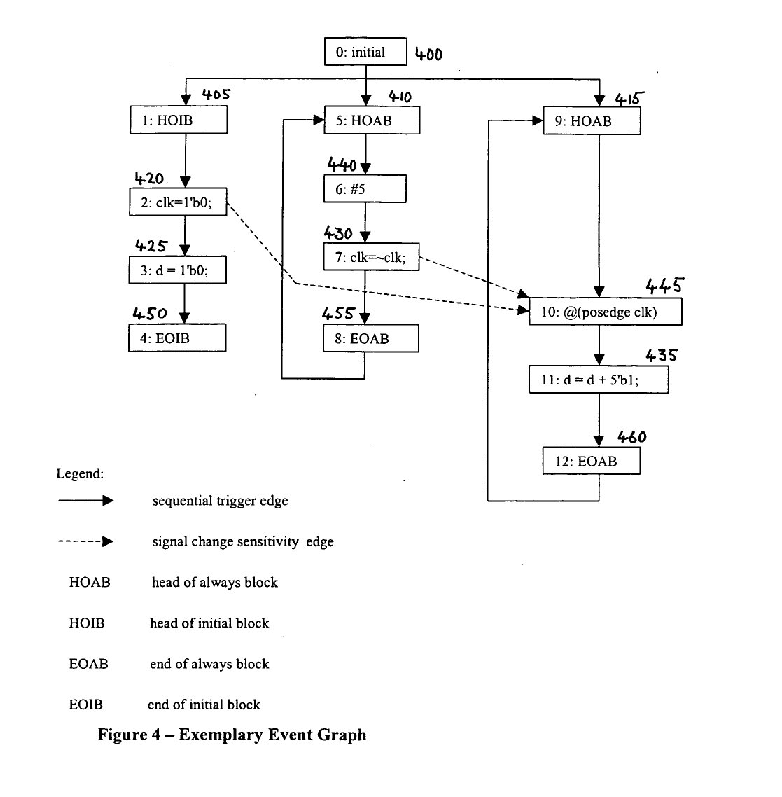

As an example of a conversion of HDL code into an event graph, FIG. 3 shows HDL code and FIG. 4 shows the corresponding event graph according to the present invention. The construction of the event graph for this example is as follows:
Vertex 0, shown at 400, is the initial vertex, from which all other vertices are reached. It is active at the beginning of simulation, and serves to activate other vertices that are defined to start at time 0 by the simulation semantics.
Vertices 1, 5, and 9 [shown at 405, 410 and 415, respectively] are head-of-block vertices. These vertices correspond to the starts of procedural blocks in the source, at lines 6, 11, and 16 respectively of FIG. 3.
Vertices 2, 3, 7, and 11 [shown at 420, 425, 430 and 435, respectively] are assignment vertices, corresponding to assignments in the source code, at lines 7, 8, 13, and 17, respectively, of FIG. 3.
Vertex 6 [shown at 440] is a delay vertex, corresponding to the delay on line 12 of the source of FIG. 3.
Vertex 10 [445] is a wait vertex, corresponding to the wait due the event control in the always statement on line 16 of the source of FIG. 3. The contents of the wait vertex match the wait in the source. In this case, the “@(posedge clk)” contained in vertex 10 is due to the “@(posedge clk)” event control in the source, in the always statement on line 16 of FIG. 3.
Vertices 4, 8, and 12 [450, 455 and 460, respectively] are end-of-block vertices, corresponding to the ends of the procedural blocks in the source, on lines 9, 14, and 18, respectively, in FIG. 3.
Sequential trigger edges indicate that a subsequent vertex follows immediately after its predecessor, arising due to sequential control flow in the source or as needed during translation. The sequential trigger edges from vertex 0 to vertex 1 (0→1), 0→5, and 0→9 arise from the translation of the elaborated parse tree to the event graph, and indicate that the head-of-block vertices 1, 5, and 9, follow immediately after vertex 0, which is scheduled at the beginning of simulation. Other sequential trigger edges arise due to translation of sequential flow in the source.
The edges 8→5 and 12→9 arise due to the semantics of an always block in the source language, which dictate that flow that reaches the end of an always block immediately returns to the top of the same always block. When control reaches line 14 of the source, it proceeds immediately to line 11; when control reaches line 18 of the source, it proceeds immediately to line 16. This is indicated by the edges 8→5 and 12→9 respectively.
A wait vertex, such as vertex 10, is reached in the usual sequential fashion, but also may be immediately re-evaluated, in the event that the wait condition is false. Once the wait condition is true, the fan-out of the wait vertex is followed. For example, wait vertex 10 is sequentially reached from vertex 9. If the wait condition, “posedge clk”, is false, the wait vertex immediately re-evaluates, until “posedge clk” is true, at which time vertex 11 is reached in the usual fashion. A wait vertex arises from an event control in the source; vertex 10 results from the event control “@(posedge clk)” on line 16 of the source.
A signal change sensitivity edge indicates a signal change dependency rather than a sequential flow. A signal change sensitivity edge, (u,v), indicates that vertex v is activated at time t if the signal assigned by vertex u changes value from time t−1 to t. For example, the signal change sensitivity edge from vertex 2 to vertex 10 indicates that a change in the value of signal “clk” due to the assignment on line 7 of the source necessitates a re-evaluation of the wait expression “@(posedge clk”) in vertex 10, corresponding the event control “@ (posedge clk”) on line 16 of the source. The signal change sensitivity edge from vertex 7 to vertex 10 indicates that a change in the value of “clk” due to the assignment on line 13 of the source necessitates a re-evaluation of the wait expression “@(posedge clk”) in vertex 10, corresponding to the event control “@(posedge clk)” on line 16 of the source.

Scheduling the Event Graph

Scheduling the event graph is a process by which an integer, known as a level, is assigned to each vertex. Event graph scheduling typically includes two steps:
Mark all back edges in the event graph.
Compute the level of each vertex in the event graph starting from the initial set of vertices and ignoring marked back edges when computing levels.

Back edges arise due to cycles in the event graph. A cycle is a set of vertices such that a path exists by following edges from one vertex in the cycle through other vertices in the cycle back to the starting vertex. For example, in FIG. 4, there is a cycle among the vertices 9, 10, 11, and 12 [415, 445, 435 and 460, respectively.]

Vertices that are part of cycles cannot have levels assigned to them. It is normal for event graphs to have cycles due to constructs that specify behavior that must happen continuously. An always block in Verilog, for example, specifies that after executing the code in the always block, execution must continue immediately at the top of the always block. This causes a cycle amongst vertices corresponding to assignments in the always block.

Levelization of cyclic paths is resolved by performing a depth-first traversal of the event graph starting from the initial set of vertices and marking each back edge. Depth-first search starts at some vertex and traverses an outgoing edge from this vertex to arrive at the next vertex. The algorithm then recursively traverses an edge from the new vertex recording each vertex that it has visited in the path. A back edge is detected when the traversal arrives at a vertex that is already in the path, indicating a cycle in the graph. By marking the back edge and ignoring it during levelization, the cycle is effectively broken, allowing vertices within the cycle to be assigned a level.

An aspect of at least some embodiments of the invention is that cycles may be cut at an arbitrary point. Back-edges in an event graph only arise due to zero-delay loops in the source code, in which case it generally does not matter where in a cycle the cut is made. Cases where it does matter include for loops and while loops in which there is zero delay through the loop. This can be handled using heuristics such as loop unrolling or including a finer granularity clock such that each loop has a non-zero delay at the finer granularity. Cycles arising due to other conditions such as a combinational logic loop may not be handled correctly by the present invention.

Levelization may be done, for example, using a combination of depth-first (DFS) and breadth-first search (BFS) algorithms. Levels are computed for each vertex using either DFS or BFS traversal as follows:
The initial set of vertices is assigned level 0.
For all other vertices v, assign a level such that level(v)>level(u) for all vertices u such that (u,v) is an incoming edge to vertex v in the event graph.

The initial set of vertices for the search comprises those vertices that are not triggered by other vertices, but are automatically triggered at the start of a time step. This includes:
The initial vertex that marks the beginning of simulation.
Non-zero delay vertices that appear in always blocks indicating that execution should be suspended until the beginning of the specified time step.

The second step can be accomplished by traversing the graph starting from the initial vertices. When traversing an edge (u,v), the level of v is set to the level of u plus one if the level of v is less than or equal to the level of u. After all edges have been traversed, all vertices will be assigned the correct level.

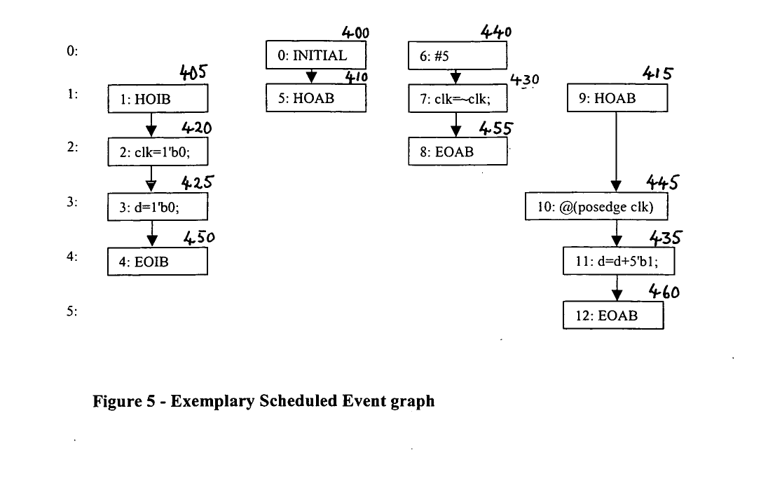

FIG. 5 presents the results of vertex scheduling for the example event graph of FIG. 4. For convenience, the same reference numerals from FIG. 4 will be used in FIG. 5 for the same elements. In this example, the level for vertex 9 [415] cannot be determined without knowing the level of vertex 12 [460] (and the level for vertex 0 [400]), but the level for vertex 12 cannot be determined without knowing the level for vertex 11 [435], and in turn knowing the level for vertices 10 [445] and 9 [415]. In short, the level for vertex 9 depends on itself. In FIG. 4, there is no zero-delay loop between vertices 5, 6, 7, and 8, [410, 440, 430 and 455, respectively] as this loop contains a non-zero delay, a delay of five time units, in vertex 6 [440]. There is a zero-delay loop between vertices 9, 10,11, and 12, arising from the always block on lines 16-18 in FIG. 3. However, further analysis reveals the presence of the event control “@ (posedge clk)” in the loop, and the fact that “posedge clk” can only be true in separate time steps due to the fact that a change from 0 to 1 in clk, the posedge of clk, can occur only due to the assignment in vertex 7, and successive executions of this assignment are separated by the delay in vertex 6. Such a loop, which is physically present in the graph, but logically is not a zero-delay loop, is called a false zero-delay loop.

Vertex 0, the initial vertex 400, and vertex 6, a non-zero delay vertex 440 are assigned a level of 0. Vertex 7 receives a level of 1, as its only fan-in vertex, vertex 6, is at level 0. Vertex 8 receives a level of 2, as its only fan-in vertex, vertex 7, is at level 1.

Vertices 1, 5, and, 9, the head-of-block vertices, receive a level of 1, as the only fan-in vertex is each case is the initial vertex, vertex 0, which is at level 0. (Back-edges are ignored during vertex scheduling.)

Vertex 2 is assigned level 2, its only fan-in vertex being vertex 1, at level 1. Vertex 3 is assigned level 3, its only fan-in vertex being vertex 2, at level 2. Vertex 4 is assigned level 4, its only fan-in vertex being vertex 3, at level 3.

Vertex 10 has multiple fan-in vertices, vertices 2, 7, and 9, at levels 2, 1, and 1, respectively. It therefore receives a level of 3, which is greater than any of the fan-in levels 2, 1, and 1.

Vertex 11 is assigned level 4, its only fan-in vertex being vertex 10, at level 3. Vertex 12 is assigned level 5, its only fan-in vertex being vertex 11, at level 4.

Associating a Trigger Function with a Vertex

In one embodiment, the algorithm to create trigger signals typically includes three steps:
Pre-allocate triggers where necessary.
Create trigger signals for each level 0 vertex in the event graph.
Propagate trigger signals from one vertex to the next, in level order.

An element of at least some embodiments of this feature is that the trigger for a given vertex is a function of the trigger of its fan-in vertices. For example, in a Verilog always block, two consecutive assignments will have the same trigger function. In accordance with the present invention, in the event graph there will be an edge from the vertex corresponding to the first assignment to the vertex corresponding to the second. Thus, if the trigger is known for the first vertex, simply propagating the first vertex's trigger along the edge to the second vertex can create the trigger for the second vertex.

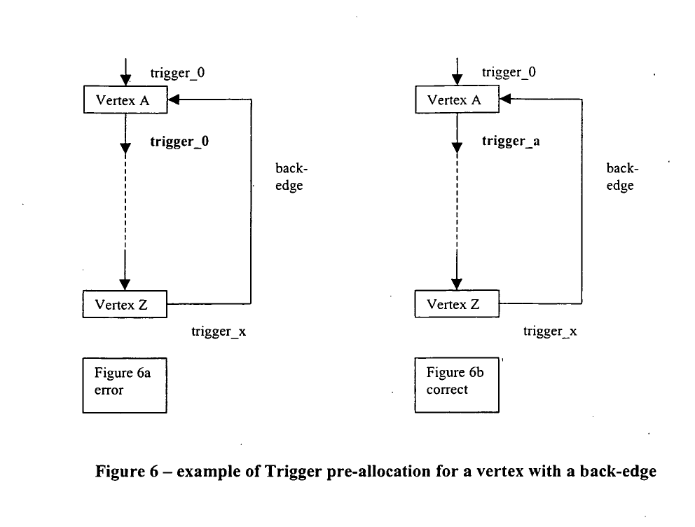

The need for pre-allocation of triggers arises due to the presence of back-edges. In accordance with the present invention, triggers are pre-allocated for each vertex that is incident to an incoming back-edge, as illustrated in FIGS. 6A-6B. This is helpful because back-edges are ignored during vertex scheduling in at least some implementations. Since the trigger for the vertices is determined by propagation from fan-ins, the target of a back edge will not have a trigger propagated to it at the point it is needed. However, it is known that eventually, the back edge target will have a trigger pushed to it.

To handle this case, a signal is created, called a pre-allocated trigger. The trigger for the back edge target is set to this pre-allocated signal. This trigger is then propagated along to create triggers for other vertices. At some point the source for the back edge will be processed. Instead of pushing the trigger for that vertex to the back edge target, the pre-allocated signal is set equal to the back edge source trigger. Thus, as shown in the error condition of FIG. 6A, a trigger_0, shown at 600, is applied at to vertex A at 605 and thence propagates to vertex Z at 610. The trigger_x returns to vertex A on a back-edge. In contrast, in FIG. 6B, the trigger_0 shown at 615 is supplied to vertex A at 620, and propagates as trigger_a to vertex Z at 625. This then returns, as trigger_x, to vertex A along the back-edge, where the back edge source trigger controls the state.

The starting point for trigger propagation is to create triggers for those vertices at level 0. There are two types: initial vertices and delay vertices that represent events that require triggering at the beginning of some future time step. Triggers are derived and propagated for each vertex in order of the level of each vertex. Vertices at level 0 are processed first. Next the vertices at level 1 are processed, followed by those at level 2, and so on up the maximum level of a vertex in the event graph.

In an exemplary arrangement, propagating the trigger for each vertex includes the following steps:
for each outgoing edge from the current vertex:
Propagate the trigger for this vertex to the target vertex.
Merge the current trigger at the target vertex with other triggers propagated from other vertices.

Merging is done by logically ORing them, indicating that the vertex is triggered if either one of the incoming triggers is active.

Collecting Assignments to Identical Targets

At the same time as each vertex is processed to perform trigger propagation, the assignment associated with this vertex is combined with other assignments to the same signal if this vertex is an assignment type vertex. The assignment vertex contains an expression in the form “signal=expression”, so the signal graph is updated with the assignment {variable, expression, trigger}, where “variable” is the variable on the left-hand-side of the assignment contained within the vertex, “expression” is the expression on the right-hand-side of the assignment contained within the vertex, and “trigger” is the trigger for the vertex. Combining this assignment with previous ones for this signal is done by creating the expression “signal=ite(trigger,expression,cur_assign), where ite is the if-then-else function, and cur_assign is the result of previous assignments to this signal. If no previous assignments have been made, the value of cur_assign is “signal(t−1)” indicating that the signal at the current time, t, is equal to its previous value at time t−1.

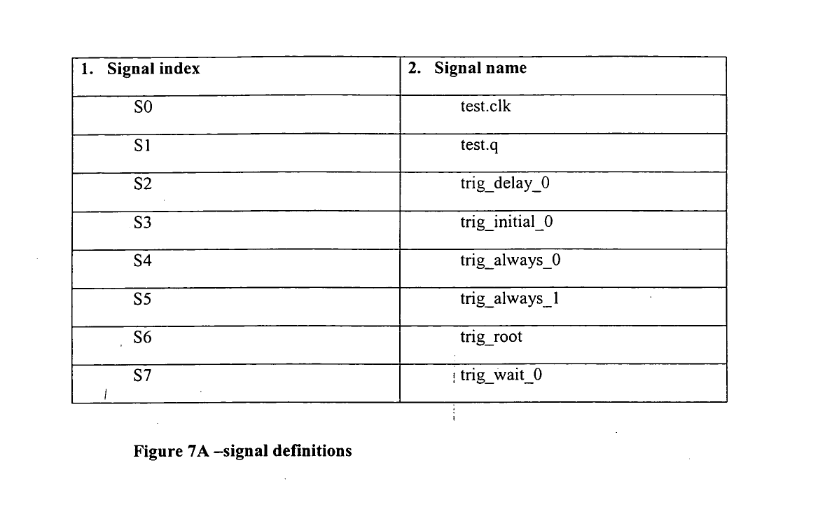

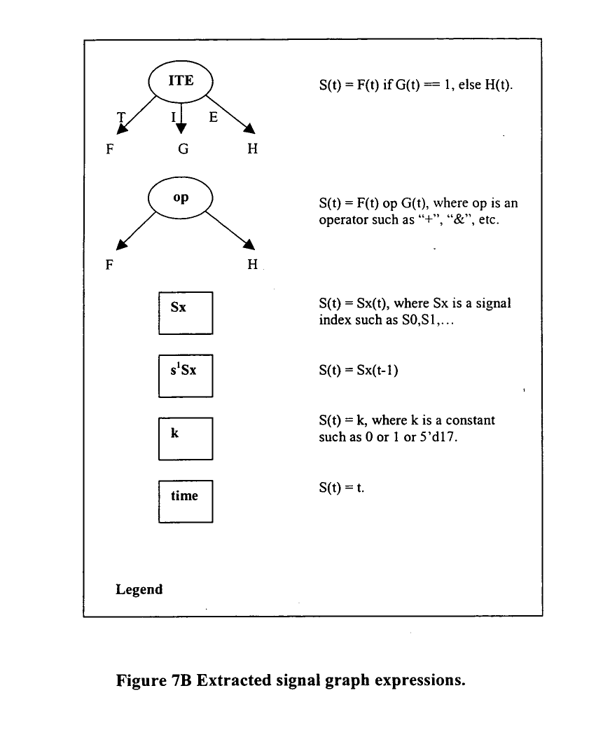

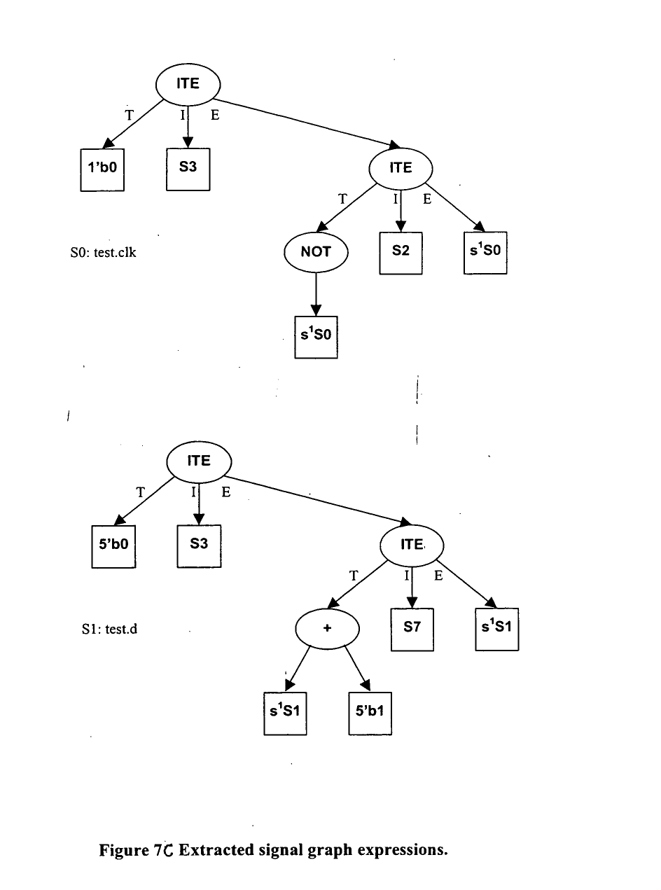

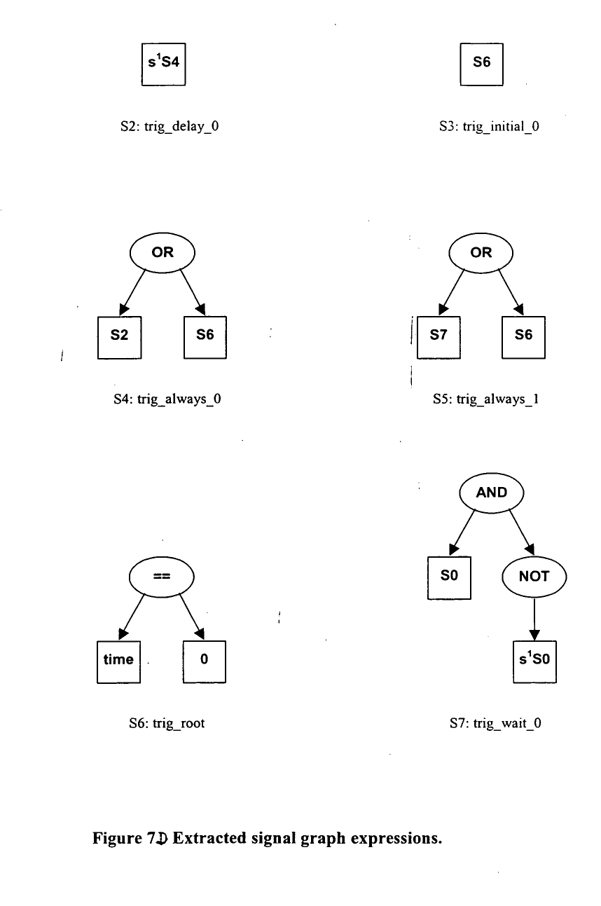

For example, please refer to FIGS. 7A-7D, and particularly the table of FIG. 7A, the legend of 7B, and the diagram of FIG. 7C for signal S0, test.clk, which results from the assignments to clk of:
test.clk=˜test.clk under trigger S2, arising from line 13 of the source in FIG. 3, and
test.clk=1′b0 under trigger S3, arising from line 7 of the source in FIG. 3.

With no assignment to a signal, the HDL semantics are that the signal retains its present value. Thus, the first step combines the first assignment with the default value: test.clk(t)=ite(S2, ˜test.clk(t−1), test.clk(t−1))—if trigger S2 is true, assign from ˜test.clk, else assign from test.clk (retain its value). See the S0:test clk portion of FIG. 7C

Combining this partial result with the second assignment yields:
test.clk(t)=ite(S3, 1′b0, ite(S2, ˜test.clk(t−1), test.clk(t−1))), which is shown graphically in the diagram for test.clk in FIG. 7C.

The following sections described how the following cases, which specifically cannot be handled by prior art methods, are handled by the present invention:
delay vertices.
wait statements.
if-then-else/case statements with delay/wait statements in the branches.

Delay Vertices

A delay vertex contains an expression that is 0 or an expression that is non-zero. The former is called a zero-delay vertex while the latter is called a non-zero delay vertex. The outgoing trigger for a zero-delay vertex is identical to its incoming trigger. For a non-zero delay vertex, the outgoing trigger is also the incoming trigger, which has been pre-allocated. The value of the pre-allocated non-zero delay vertex trigger is established as a trigger value is propagated to it.

A trigger can be created for each non-zero delay vertex, but the value is not yet known, and so defining the trigger signal must be deferred until a value is propagated to this vertex. For example, suppose there is a delay between the assignments within an always block.

always begin
a = ...;
#10
b = ...;
#10
end

In this case, a and b will be assigned at different times, thus, they must have different trigger functions. Delay statements, according to HDL semantics, cause an always block to suspend execution for a fixed number of time steps. At the beginning of the time step at which execution is resumed, the next sequential assignment will be put on the event queue. This assignment has no ordering relationship with assignments preceding the delay statement in the always block since it is executed in a different time step. This means that levelization may cause an assignment immediately succeeding a delay statement to be ordered ahead of an assignment immediately preceding it.

In accordance an exemplary arrangement of the present invention, the trigger function for the delayed assignment is equal to the trigger function of the assignment preceding the delay statement, but delayed by the specified amount:
trig_dly_out(t)=trig_dly_in(t−k)
where trig_dly_out is the trigger function for assignments following the delay and trig_dly_in is the trigger function for the assignment immediately preceding the delay and k is the delay amount. However, the trig_dly_out will be associated with a vertex with level 0, while the trig-dly-out will be associated with a vertex with level>0. Therefore, in accordance with the present invention, the trig_dly_out trigger is pre-allocated as discussed above. Once the vertex corresponding to the trig_dly_in is processed in level order, the function for trig_dly_out will be filled in using the method described above.

Wait Statements

Determining the outgoing trigger for a wait vertex is more involved, as the signal extraction process must preserve the HDL semantics that a wait must first be reached, or sensitized, before the wait condition can be tested, at which point execution may either be suspended or be resumed.

Because assignments after a wait may be triggered in different time steps than those prior to the wait, the wait statement causes a new trigger to be created for those statements following the wait. Wait statements can be either level-triggered or edge-triggered. Level-triggered waits suspend execution if the value of the wait condition is false and resume when the condition becomes true. If the condition is true when the wait statement is executed, no waiting occurs and the wait is effectively treated as a null operation. An edge-triggered wait also suspends execution when executed if the wait condition is false and then resumes when the condition becomes true, but if the condition is true when the wait is executed, the wait will suspend until the condition becomes false and then goes true again.

Wait statements have a sensitizing condition and a resume condition. The sensitizing condition specifies when the wait statement will start waiting (i.e., at what point it will cause execution of the always block to suspend) and the resume condition specifies when the wait will resume. The sensitizing condition for a wait is generally the incoming trigger for the event graph vertex corresponding to the wait. The resume condition is specified by the user in the source code and is a function of signals defined in the source code. For example, in the following code,

...
start = 1′b1;
wait(done);

the statement “start=1′b1” will have a trigger and the event graph corresponding to this vertex will have an edge to the wait vertex. Therefore, the trigger from the start vertex will be propagated to the wait vertex and become the sensitizing condition for the wait. The “done” signal is the resume condition.

It is possible that the sensitizing and resume conditions become true in the same time step. In this case it is necessary to know the ordering of the sensitizing event relative to the resume event in order to determine the correct behavior. There are three cases to consider:
The wait is level-sensitive.
The wait is edge-sensitive and the sensitizing event occurs before the resume event when both occur in the same time step.
The wait is edge-sensitive and the sensitizing event occurs after the resume event when both occur in the same time step.

In the first case, since the wait resumes if the resume condition is true, it does not matter whether the wait is sensitized after or before the resume condition becomes true if both occur in the same time step. For edge-sensitize waits, if the sensitizing condition occurs before the resume condition transitions from false to true, then the wait will act as a null operation. If the resume condition transitions from false to true in the same time step as the sensitizing condition becomes true, but the resume condition is ordered before the sensitizing event, then the wait does not see this transition and must wait for the next transition. In one embodiment, signals are only allowed to transition once per time step, thus, this subsequent edge must occur at some future time step.

It is helpful to remember that, in at least some embodiments, a wait was sensitized until the resume condition becomes true. In the current invention, this is accomplished by introducing state to remember this condition. In one embodiment, a new signal is introduced which can take on the value true or false. This signal behaves as a set/reset latch, being set when the sensitizing condition for a wait occurs and reset when the resume condition occurs. The exact functions for this latch for each of the three cases above are given below:
s_wait(t)=!resume(t−1) & s_wait(t−1)|!resume(t−1) & sensitize(t−1).
s_wait(t)=!resume(t−1) & s_wait(t−1)|!resume(t−1) & sensitize(t−1).
s_wait(t)=!resume(t−1) & s_wait(t−1)|sensitize(t−1).

The state signal is called “s_wait” as shown in the S7 portion of FIG. 7D In the first case, a level-sensitive wait enters the wait state if in the previous time step, the sensitizing condition was true and resume was not true, or if it was in the wait state in the previous state and no resume has yet occurred in the current time step. An edge-sensitive wait in which the sensitizing condition is ordered before the resume behaves identically to a level-sensitive wait, thus, they have the same wait state function. An edge-sensitive wait in which the resume is ordered before the sensitization will wait at least one time step no matter what; thus if sensitize was true in the previous time step, the wait state will be active in the current time step. Otherwise, it will remain in the wait state until a resume is seen, just as in the level-sensitive case.

The outgoing trigger of a wait vertex is a signal with a value that indicates that the wait has been sensitized and the resume condition is true. In the case of a level sensitive wait, or the case in which the sensitizing condition is ordered before the resume, the wait could have been reached during the present time step or during a previous time step. In the case where the sensitizing condition is ordered after the resume condition, the wait must be reached during a previous time step.

Equations for the wait vertex outgoing trigger for the three cases:
s_go(t)=sensitize(t) & resume(t)|wait(t) & resume(t)
s_go(t)=sensitize(t) & resume(t)|wait(t) & resume(t)
s_go(t)=wait(t) & resume(t)
   where “s_go” is the the trigger propagated along the outgoing edges of the wait vertex.
   if-then-else and case statements

Prior art methods exists for merging assignments in different branches of an if-then-else or case statement as long as the if-then-else/case statements contain no delay or, wait statements. In accordance with the present invention, if-then-else and case statements containing delays or waits in different branches can be combined. An if-then-else or case statement is translated to one or more expression type vertices in the event graph. In accordance with the present invention, for these cases, the trigger is not modified for the different branches unless a delay or wait appears in one of the branches. Instead, for the normal case, a guard expression is created and the trigger condition for a vertex is the logical AND of its trigger and guard. Guards for vertices can be created using prior art methods.

For an expression vertex, two new guard signals are created, one reflecting the condition that the expression specified in the vertex is true, the other reflecting that the condition is false. The guard reflecting that the expression is true is propagated along outgoing edges annotated “true”, while the trigger reflecting that the expression is false is propagated along outgoing edges annotated “false”.

If a delay or wait occurs in one branch of an if-then-else, then the outgoing trigger of the wait/delay vertex in the if-then-else branch is modified to be equal to the logical AND of the guard and trigger. The outgoing trigger is propagated along the outgoing edges and the outgoing guard is set to logical true.

At the end of the if-then-else/case statement, all the triggers and guards must be ORed. If no wait or delay appeared in the if-then-else/case, then all incoming triggers are the same and the merged trigger is equal to the incoming triggers. The OR of all incoming guards is equal to logical true or the guard that was in effect at the time of the if/case statement if the current if/case is nested. If a delay or wait occurred in one of the branches, then the incoming triggers to be merged may be different. In this case, the triggers and guards must be merged by ANDing the trigger and guard for each incoming edge before ORing the combined trigger/guard for all incoming edges. The resulting expression is the outgoing trigger for the merged set of incoming edges and the outgoing guard is the logical value true.

Final Signal Graph Example

The signal graph resulting from one embodiment of the present invention for the scheduled event graph of FIG. 5 is shown in FIGS. 7A-7D.

The diagram for signal S0, test.clk, illustrates that if trigger S3—the trigger of the initial block on line 6 of the source, in FIG. 3—is true, then test.clk is assigned the value 1′b0. This corresponds to the assignment “clk=1′b0” on line 7 of the source. If instead the trigger S3 is false, then if the trigger S2—the trigger following the delay statement on line 12 of the source—is true, then test.clk is assigned the logical not of the value of test.clk from the previous time step; this corresponds to the assignment clk=˜clk on line 13 of the source. Otherwise—both trigger S2 and trigger S3 are false, test.clk is assigned the value of test.clk from the previous time step—test.clk retains it value.

The diagram for signal S1, test.d, shown in FIG. 7C, is interpreted similarly. If trigger S3—the initial block trigger—is true, then test.d is assigned the value 5′b0; this corresponds to the assignment “d=5′b0” on line 8 of the source. If instead the trigger S7—the trigger following the “@(posedge clk)” event control is true, then test.d is assigned the value test.d from the previous time step plus 5′b1; this corresponds to the assignment “d=d+1” on line 17 of the source. If neither trigger S3 nor S7 is true, then test.d is assigned the value of test.d from the previous time step—test.d retains its value.

The diagram for S2, trig_delay_0, shown at the top of FIG. 7D, shows that the value of the trigger signal that follows the “#5” on line 12 of the source to be the value of signal S4—the trigger signal of the always block on line 11 of the source—from the previous time step. S2 is the value of S4 delayed by one time step.

S3, trig_initial_0 (shown at the upper right of FIG. 7D), the trigger signal of the initial block that starts on line 6 of the source, is shown as S6—the trigger of the initial vertex. In this example, S3 is activated at the beginning of simulation, and never again.

S4, trig_always_0 (shown at the left middle portion of FIG. 7D), the trigger of the always block that starts on line 11 of the source, is the logical OR of triggers S2 and S6. S6 is the trigger of the initial vertex, indicating that the always block is activated at the beginning of simulation. S2 is the trigger that follows the delay on line 12 of the source, indicating that the always block on line 11 is also activated immediately following the previous iteration of itself, as is required by the HDL semantics.

S5, trig_always_1 (shown at the right middle portion of FIG. 7D), the trigger of the always block that starts on line 16 of the source, is the logical OR of the triggers S7 and S6. S6 is the trigger of the initial vertex, indicating that the always block is activated at the beginning of simulation.

S7 is the trigger that follows the @(posedge clk) event control on line 16 of the source, indicating that the always block on line 16 is activated immediately following the previous iteration of itself, as is required by the HDL semantics.

S6, trig_root (shown at the lower left of FIG. 7D), the trigger of the initial vertex in the event graph, not associated with any particular line in the source, has the value “time==0”, indicating that the initial vertex is activated when simulated time is 0, that is, at the beginning of simulation, and never thereafter.

S7, trig_wait_0 (shown at the lower right of FIG. 7D), the trigger following the @(posedge clk) event control on line 16 of the source, is the logical AND of the value of signal S0 (clk) from the current time step and the logical inverse of the value of signal S0 from the previous time step. That is, S7 is true if and only if the value of clk in the previous time step was 0 and the value of clk in the current time step is now 1. That is, a positive, or rising, edge of the clk signal has been detected.

A key issue in some synthesis environments that require combining multiple assignments into a single assignment is the ability to handle assignments at different time steps created as a result of delay and/or wait statements. Prior art synthesis methods are limited in that they only handle a single, implied global trigger. This means that all assignments that are combined must be triggered in the same time step implying that there can be no waits or delays in the synthesized code. The present invention overcomes this limitation by:
introducing explicit trigger signals.
associating a trigger with every assignment.
specifying methods for creating triggers that allow waits and delays to be handled.

As a result, a signal graph, which has multiple assignments for a signal combined into a single assignment, to be created for the entire set of HDL constructs.

Representing Signal Values Using BDDs

Simulation is a process which takes in a model of a device and a test case consisting of a set of signals and operations on those signals over a number of simulated time steps. The input to the simulation process is source code that describes how signals behave as a function of other signals. The goal of the simulator is to transform this representation into one in which signals are a function of time. Typically, the simulation result is a function per signal that maps each time step of the simulation to the value of the signal for that time step. This output function is also called a time history function. Therefore, simulation requires representing two types of functions: those representing source code and those representing time histories. Our invention is to use BDDs to represent time history functions. Prior art methods have only used BDDs to represent source code functions. Compressed history functions have been shown to be beneficial and prior art methods have used methods other than BDDs to compress history functions. Using BDDs is beneficial because BDDs have the advantage of being very compact for many function types. The use of BDDs also allows the simulator more flexibility because BDDs are more easily manipulated than other history function representations.

Having a compact representation of time history functions is beneficial because it improves simulation performance. In particular:
Keeping an internal history of signal values over time allows simulation to be efficiently performed in parallel across multiple time steps resulting in faster simulation.
Storing time histories of signals on disk during simulation allows the signal history to be viewed after simulation completes. A compact representation of the time history minimizes the amount of time required to transfer data between disk and main memory, thereby improving both simulation and waveform viewing performance.

Prior art methods for representing signal history include:
Specifying the signal value for each time step in a table.
Recording a list of signal value changes. A record comprises a time step and value. Value changes are only recorded if the signal's value changes from one time step to the next. If signal values do not change often, recording only value changes saves space compared to saving the entire signal history.
Using standard text compression algorithms such as Lempel-Ziv to compress signal value change lists.
Storing only a partial history:
Only storing the value of each signal every few time steps, requiring work to be done during waveform viewing to fill in the missing time steps.
Storing the values of a subset of signals for all time, also requiring work to be done during waveform viewing to fill in missing signals (see related claims).

A well-known technique for compactly representing sets of functions is to use a shared binary decision diagram (BDD). A BDD is a directed acyclic graph with two types of vertices: terminals and non-terminals. Terminals are labeled with a constant value and have no outgoing edges. Non-terminals represent functions and are labeled with a Boolean variable and have two outgoing edges. A non-terminal with label x and its left edge pointing to vertex f and its right edge to vertex g represents the function h(x)=□x & f|x & g, where □, &, and | are standard Boolean NOT, AND, and OR operators. A shared BDD is one in which a single vertex is used to represent a sub-expression that is common between different functions. For example, if two functions, f(x,y) and g(x,y), both are equal to the function “x & y”, then, instead of creating two BDD nodes, these functions point to the same BDD node representing the function “x & y”.

Simulators have used shared BDDs to represent the source code in order to improve simulation performance. An example of this is [U.S. Pat. No. 5,937,183 “Enhanced binary decision diagram-based functional simulation”, Ashar, Sharad]. Since this method uses BDDs as a representation of the source, the BDDs created are functions of the signals (in bit-vector form) in the design. The present invention uses BDDs to represent the time history functions of signals. These BDDs are functions of time represented as a vector of Boolean bits. History functions for multiple signals can use a shared BDD structure to maximize sub-expression sharing across both signal values and time. Sharing is possible because the domain of the time history functions is the same for all signals, namely, a bit vector representing time. Also, the range of all time history functions is the same, namely, constants as defined by the hardware description language, such as 0, 1, 2, etc. Thus, if two different signals have the same history, even if for a short interval, the function representing this piece of the time history need only be generated once and then pointed to by the two signal value history functions. The benefit of this is that signal value histories for all signals can be stored compactly and, because they are BDDs, can be efficiently accessed and manipulated during simulation, something that prior art representations cannot do.

As an example assume a test case has the following signal definitions:

reg clk;
reg [4:0] cnt;
initial clk = 1′b0;
initial count = 0;
always begin
#1
clock = ˜clock;
end
always @ (posedge clock) begin
count <= count + 1;
end

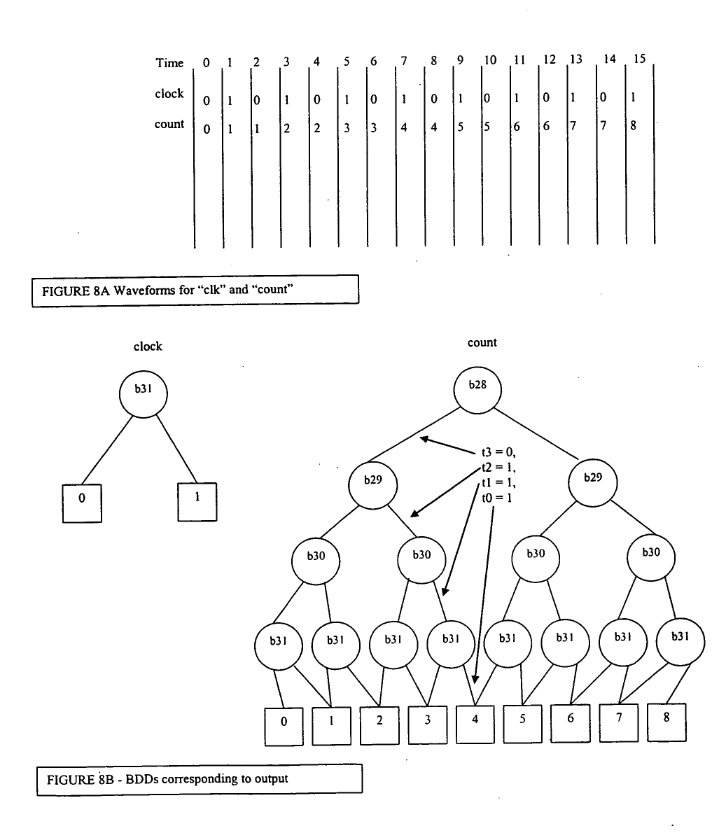

FIG. 8A shows the waveforms for “clock” and “count” over 16 time steps. Time steps are delineated with vertical bars in the figure and are labeled with the appropriate time at the top. The waveform for “clock” is labeled “clock”. At time 0, the value is 0 as defined in the source code line 3. The always block at lines 5-8 specifies that after one time step delay, “clock” is inverted. Therefore, at time step 1, “clock” is set to 1 and at each following time step, it is set to its opposite value. The waveform for “count”, labeled “count” in the figure, is initialized to 0 as specified in source code line 4. The always block (lines 9-11) specifies that “count” is incremented whenever the positive edge of clock occurs (transitions from 0 to 1). Thus, “count” increments to 1 at time step 1, 2 at time step 3, and so on up to 8 at time step 15.

BDDs corresponding to the waveforms for signals “clock” and “count” are shown in FIG. 8B. To encode these waveforms as BDDs, time is represented as a bit vector of, for example, 32 bits numbered t31-t0 with t0 being the lowest ordered bit. These are mapped to BDD variable indices b0-b31 with b31 being the lowest order bit. BDD variable indices must appear such that vertices with lower order indices appear above vertices with higher numbered indices, thus, the need to map time bits to BDD variable bits. The left outgoing edge points to the subfunction assuming that the variable labeling this node is equal to zero and the right outgoing edge points to the subfunction assuming this nodes bit is equal to one. The function for “clock” is easy to see. From the waveform, it is obvious that “clock” is 0 in even time steps and 1 in odd time steps. The lowest order bit, t0 (=b31), distinguishes between even and odd time steps and all other bits don't matter. Thus, the BDD representing this function comprises a single node labeled with b31 with the left branch pointing to terminal 0 indicating that the value of this function is 0 whenever b31=0 and the right branch points to terminal 1 indicating the value is 1 whenever b31=1.

The BDD for “count” is more complicated, but it is easy to see that it is correct by following a path from the top vertex (called the root) to a terminal and recording the value of each bit along the way. To find the value of a given time step, convert the time value to a binary vector. For example, to find the value for time step 7, first convert it to the binary vector “0111”. This specifies the values for BDD variables b28-b31 as b28=0, b29=1, b30=1, and b31=1 (note that in this example, 0-15 are valid and, thus, BDD variables b0-b27 are not needed). Follow the path from the root, taking either the left or right branch depending on the value of the appropriate bit in the bit vector. In this case, starting from the root, the left branch is taken because b28=0 as indicated by the label “b28=0” in FIG. 8B. At the next vertex the right branch is taken as indicated by the label “b29=1” followed by the right branch for the next two vertices as indicated by labels “b30=1” and “b31=1” arriving at terminal with the value “4”, which is the value of count for time step 7.

BDDs are created and manipulated using standard algorithms for creating and manipulating a type of BDD called a reduced, ordered BDD (ROBDD). The BDD shown in FIG. 8B for the “count” BDD is actually a multi-terminal BDD (MTBDD) Our method allows any type of BDD to be used, including, but not limited to, ROBDDs and MTBDDs.

Computing a Minimal Set of Signals for Simulation

The user wants the simulation to finish as quickly as possible in order to view the results, typically signal value history waveforms. In general the user will only need to look at a small fraction of the total signals. Since the actual signals the user wants to view are not known in advance, simulators generally need to simulate all signals, thus requiring significant effort and time to simulate signals that the user may not be interested in. Prior art methods finish all simulation before allowing the user to view any waveforms. In at least some implementation, the present invention simulates a minimal number of signals for all time steps to allow the user to start viewing waveforms as quickly as possible before all signals have been simulated. Missing signal values are generated on demand during waveform viewing. The key idea is to carefully select the minimal set of signals for simulation such all other signal values can be generated quickly during waveform viewing if necessary. Simulating only a minimal set of signals reduces simulation effort, thereby improving simulation performance. This is beneficial because it speeds up simulation and allows the user to start viewing waveforms sooner than with using prior art simulators.

The minimal set is chosen such that values for all other signals for a given time step can be computed quickly. This metric is based on the fact that, when a user is debugging and attempts to display the value of a particular signal, the simulator must produce that value more-or-less instantaneously, usually within a small number of seconds. Since simulation speed is on the order of a few cycles per second up to hundreds of cycles per second, this requirement translates to determining a minimal set of signals from which all other signal values can be determined within a small number of cycles.

A minimal set is one that meets some specified criteria and deletion of any member of the set creates a set which does not meet the criteria. It is possible to compute the absolute minimum-size set of signals required that meet this criteria, however, computing the minimum-sized set is NP-complete, meaning that is likely to be computationally too expensive to compute. Thus, the current invention proposes computing a minimal set. Note that all minimum-sized sets are also minimal, but not all minimal sets have minimum size.

Steps for computing a minimal signal set:
Create an extracted signal graph from the simulation source code.
Create a dependency graph, which is a directed graph in which vertices represent signals and edges represent signals that are functions of other signals.
Compute the strongly connected components (SCCs) of the dependency graph.
For each SCC, compute a minimal number of vertices which, if all outgoing edges from each of these vertices are cut, the resulting subgraph is no longer a SCC.
The minimal set of signals is the union of set of cut vertices for each SCC.

Each of these steps is described in detail below.

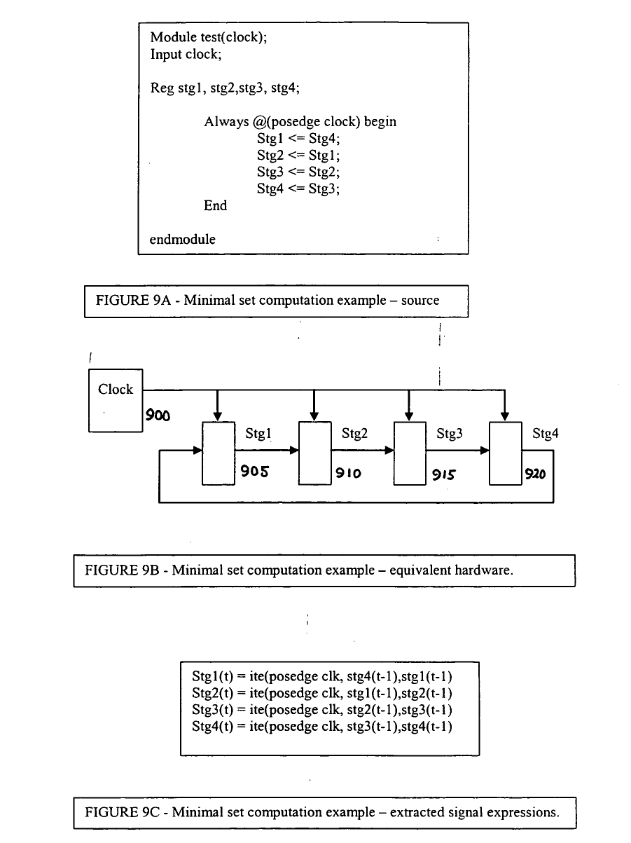

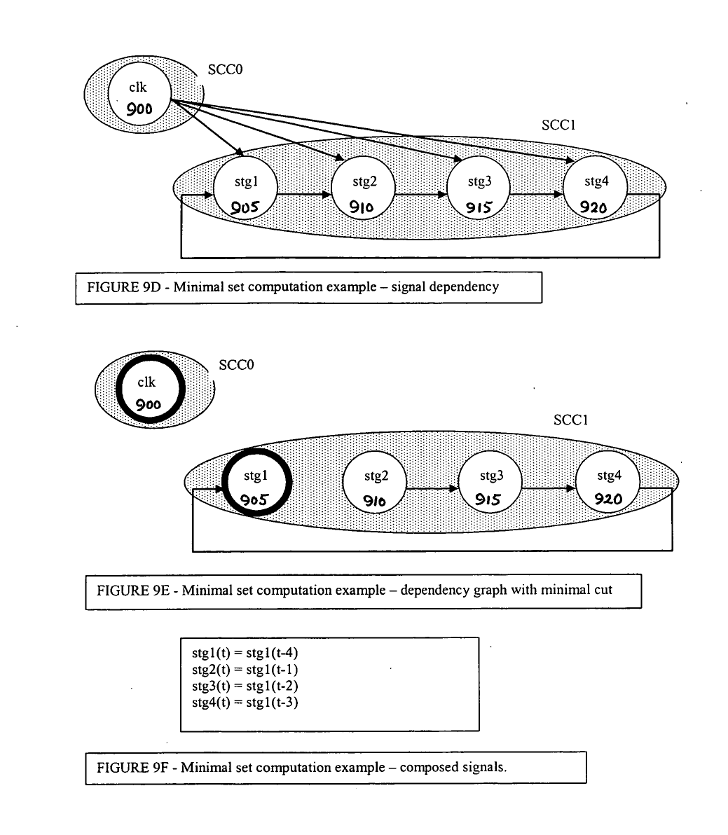

The input to the minimal set computation is the extracted signal graph. FIGS. 9A-9 F show an example of a simple pipeline. FIG. 9A is the Verilog source code for the example. The design name is “test” (line 1) with a single input “clock” (line 2). There are four stages, each with a corresponding signal named “stg1”, stg2”, “stg3”, and “stg4” (line 3). Each stage is updated at each positive edge transition (0 to 1) of the input clock (line 4). Consequently, the trigger for each assignment in lines 4-7 is the expression “posedge clk”. “stg1” is a function of “stg4” (line 4), “stg2” is a function of “stg1” (line 5), “stg3” is a function of “stg4” (line 6), and “stg4” is a function of “stg3” (line 7). This can be represented by the hardware illustrated in FIG. 9B, in which the clock 900 clocks the four stages indicated at 905, 910, 915 and 920, respectively, with the output of the fourth stage feeding back to the input of the first stage.

A dependency graph is a directed graph in which vertices represent signals and and directed edge, (u,v), indicates that an assignment to signal v is a function of signal u. FIG. 9D shows the dependency graph for the example. There is a vertex for each signal: “clock”, “stg1”, “stg2”, “stg3”, and “stg4”. Since each assignment has a trigger function that is dependent on “clock”, there is an edge from the “clock” vertex to “stg1”, “stg2”, “stg3”, and “stg4”. Corresponding to each assignment, there is an edge from “stg1” to “stg2”, “stg2” to “stg3”, “stg3” to “stg4”, and “stg4” back to “stg1”.

Signals that are dependent on themselves are called sequentially dependent A signal may be directly or indirectly sequentially dependent through other signals. In the example, “stg1” is indirectly sequentially dependent because there is an edge from “stg1” to “stg2”, from “stg2” to “stg3”, from “stg3” to “stg4”, and from “stg4” back to “stg1”. Minimal sets consist only of sequentially dependent signals since to compute the value of a sequentially dependent signal at some time t requires simulating from time 0. For example, a counter (count=count+1) at time t is equal to the value of the counter in the previous time step plus one, which means that it is also a function of the counter at time 0. If the counter is initialized to 0 at time 0, then at time 1000, its value will be 1000. However, if the counter is initialized to 1, then the value at time 1000, will be 1001. A signal that is not sequentially dependent may be dependent on other signals. It is always possible, as discussed below, to make all signals dependent on some subset of sequentially dependent signals. Therefore, minimal sets only consist of sequentially dependent signals.

All sequentially dependent signals do not necessarily need to appear in the minimal set. For example, in FIG. 9C, “stg1”, “stg2”, “stg3”, and “stg4” are each sequentially dependent, however, only one of them needs to appear in the minimal set. Assume that “stg1” is selected as the signal to add to the minimal set. The criteria for adding signals to the minimal set is that the signal cannot be generated quickly given values for all existing minimal set signals over all time. The value of “stg2” is just the value for “stg1” one time step later. Thus, if “stg1” is in the minimal set and the simulator has generated values for “stg1” for all time, the value of “stg2” can be computed at time t by loading the known value of “stg1” at time t−1 into the simulator and then simulating for one time step. This simulation is fast since it is only for one cycle, therefore “stg2” does not need to be included in the minimal set if “stg1” is included. Signals “stg3” and “stg4” also do not need to be included if “stg1” is in the minimal set since both are equal to the value of “stg1” two or three time steps later.

The key observation from the above example is that, given a set of mutually sequentially dependent signals, selecting one of these to be a member of the minimal set may eliminate other signals in the sequentially dependent set. A general algorithm for performing this computation given an arbitrary signal dependency graph computes a set of cut vertices of the strongly connected components of the signal dependency graph.

A directed graph, G=(V,E), is connected if for all pairs of vertices, u and v, either there is a path from u to v or a path from v to u. A strongly connected component (SCC) of a graph is a maximal set of vertices U⊂V such that for every pair of vertices u and v in U, there is a path from u to v and a path from v to u. Computing SCCs use standard algorithms that are known in the art.

The minimum set of signals required to simulate an SCC is equal to the minimum set of signals required to cut the SCC such that it is no longer strongly connected, but still remains connected. A cut is made by selecting a signal and then deleting all of the outgoing edges from this signal's corresponding vertex in the dependency graph. Finding the minimum set of cuts for a SCC is an NP-complete problem (see M. Garey and D. Johnson, Computers and Intractability A Guide to the Theory of NP-Completeness, W. H. Freeman, New York, 1979, ISBN 0-7167-1045-5). Because of the intractability of solving NP-complete problems, the present invention computes a minimal cut set. A minimal cut is one such that, after deleting outgoing edges from cut vertices, the SCC is no longer strongly connected but remains connected. A minimum-sized cut set is also a minimal cut set, but the inverse is not true.

One algorithm that finds a good minimal cut set for a SCC is:

Initially, the minimal cut set is empty.

choose the vertex in the SCC with the highest value of min(fanin,fanout), where fanin represents the number of incoming edges to the vertex and fanout is the number of outgoing edges,

cut the SCC at this vertex by deleting outgoing edges from the cut vertex. This cut will break the SCC into a combination of SCCs and connected vertices.

Add the cut vertex to the minimal signal set.

Recursively compute the minimal cut set of each sub-SCC created in step 3 until there are no more SCCs.

FIG. 9E shows the result of computing a minimal cut set. There are two SCCs in the design: SCC0 consists of the single signal “clock” and SCC1 consists of signals “stg1”, “stg2”, “stg3”, and “stg4” which are shown for convenience with the same reference numerals as in FIG. 9B. The “clock” signal shown at 900 may or may not need to be cut, however, clocks are usually generated using an expression such as “clock=˜clock” which makes it sequentially dependent. If “clock” is sequentially dependent, as is assumed in this example, it would be added to the minimal set since it is the only signal in SCC0. In SCC1, all signals have the same fanin and fanout, therefore, in step 2, the algorithm is free to choose a vertex arbitrarily. In the example in FIG. 9E, signal “stg1” is selected as the cut vertex. The outgoing edge from “stg1” to “stg2” in the dependency graph is deleted. The resulting graph shown in FIG. 9e is no longer strongly connected, but is still connected meaning that the set {“stg1” represents a minimum cut for SCC1.

In FIG. 9E, the vertices “clock” and “stg1” are the cut sets for their respective SCCs as indicated in the figure. The figure also shows the result of deleting the outgoing edges from these vertices to show that the remaining vertices in the SCCs remain connected. This demonstrates the necessary condition for being a minimal set. To demonstrate that this is sufficient, it is necessary to show that cutting any other vertex causes the SCC to become disconnected. If, in SCC1, either “stg2” or “stg3” or “stg4” is cut, the SCC becomes disconnected, therefore {“stg1”} is a minimal set for SCC1 and {“clock”,“stg1”} is the minimal set of signals for this example.

To simulate using a minimal set requires composing signal expressions such that all signal expressions are functions of signals in the minimal set only. Given functions f(x) and g(x), f composed with g is the function that results in substituting x in f(x) with g(x) yielding f(g(x)). One way to do this is to order the cut dependency graph such that all incoming dependencies for a given vertex are ordered before that vertex. Composition done in dependency order will result in all signals being functions only of minimal set signals.

For example, dependency ordering results in the order “clock”, “stg2”, “stg3”, “stg4”, “stg1” for the cut dependency graph shown in FIG. 9E. The “clock” signal does not need composition since this is the only vertex in SCC0. Signal “stg2” does not need composing since it has no incoming dependencies except for “stg1. “stg3” is composed with “stg2” making “stg3'a function of “stg1”. Signal “stg4” is then composed with the resulting expression for “stg3” making it also a function of “stg1”. Lastly, “stg1” is composed with the resulting expression for “stg4”, making “stg1” a function of “stg1”. The resulting composed expressions for signals “stg1”, “stg2”, “stg3”, and “stg4” are given in FIG. 9F. Note that each signal is a function of “stg1” only. Signals “stg2”, “stg3”, “stg4” are no longer sequentially dependent and that “stg1” is the only sequentially dependent signal and is the only signal that needs to be simulated for all time.

Thus, computing a minimal set of signal has the advantage of reducing the number of signals that need to be simulated for all time steps. This saves simulation effort and saves space, both of which improve simulation performance.

Out-of-Order Simulation

Simulation typically comprises a design plus test case describing a set of signals and operations on these signals written in a hardware description language such as Verilog. Test cases perform operations that inject values into the design's input signals and checks output signal values from the design over a simulated time period. The goal of the simulator is compute the value of all signals for all time steps of the simulation. Prior art simulation methods are time-ordered. That is, all signal values in both the design and test are updated at time t before any signal is updated at time t+1. An aspect of the present invention is that it includes methods for performing signal updates out-of-order relative to time. Out-of-order simulation occurs if, for example, signal A is simulated at time step t+1 before signal B is simulated at time step t. Out-of-order simulation allows optimizations that improve simulation performance that are not possible in conventional time-ordered simulation. As an example of possible optimizations:
Optimizing signal expressions across time steps to reduce the amount of computation per signal over time as described in [this patent, reducing time steps] is possible.
Enabling parallel updates of a signal across time steps as described in [this patent, binary to symbolic conversion] is possible.

In conventional simulation products, the basic algorithm for simulation is as follows:

Read in the model and test case.
Initialize all signals to their initial value.
For each time step t from 0 to last_time_step {
For each signal s in the model and test {
Compute the value of s for time step t;
}
}

Prior art efforts in this area all concentrate on trying to optimize the inner loop. There are two basic methods: oblivious simulation and event-driven simulation. In oblivious simulation, all signals are updated at each time step. One type of oblivous simulation is called levelized, or, cycle-based simulation. In cycle-based simulation, signals are sorted into an order such that, for a given signal, all signals it is dependent upon have already been updated, meaning that each signal need only be updated once per time step, thereby reducing simulation time. The result is that computation in a given time step is reduced, but this does not allow optimization across different time steps.

It is common for only a small fraction of the total number of signals to change values at each time step. Oblivious simulation has the disadvantage of evaluating signals even if no input signal changes occur. Event-driven simulation tries to eliminate this overhead by evaluating a signal at a given time step only if a dependent input changes at that time step. Since it is only concerned with reducing computation at a given time step, conventional event-driven simulation cannot optimize across multiple time steps.

Compiled-code simulators generate code that can be executed directly on a computer. This reduces the number of instructions that need to be executed per event compared to an interpreted simulator. However, conventional compiled-code simulators are either oblivious or event-based, meaning that they also cannot optimize across time steps. As a result, prior art methods cannot optimize across time steps even though it would be advantageous to allow such optimizations in order to improve simulation performance.

In an exemplary arrangement of the present invention, out-of-order simulation is used to perform signal updates. Instead of iterating over time in a strict temporal order, out-of-order simulation iterates over signals as follows:

Read in model and test.
Initialize all signals to their initial value.
For each signal s in the model and test {
For each time step t from 0 to last_time_step {
Compute the value of s for time step t;
}
}

The effect of this is that signal updates are performed out-of-order with respect to time. For example, in the above algorithm one signal will be updated for times 0, 1, etc. up to the last time step before the next signal is updated for time 0. The benefit is that this allows optimizations across multiple time steps which result in improved simulation speed. In particular, the following optimizations are possible:
Sequences of signal updates to a single signal across multiple time steps to be optimized, such as by reducing the number of time steps needing simulation as exemplified by [this patent, reducing the number of time steps].
Updates of signals across multiple time steps to be performed in parallel as exemplified by [this patent, binary to symbolic conversion].

In practice, however, the inner loop cannot be parallelized if the signal being simulated is sequentially dependent. A signal is sequentially dependent if its value at some time step is a function of itself at some previous time step. This may be directly as, for example, in a counter in which the update function is “count=count+1”, or indirectly through a sequence in which updating the current signal affects updates of other signals that ultimately affect the value of the current signal. However, it is still possible to perform out-of-order simulation between different sequentially dependent signals that are independent of each other. One way of doing this is to compute the strongly connected components of the signal dependency graph and then iterate across the different components as shown in the following algorithm:

Read in model and test.
Create the signal graph.
Create the signal dependency graph.
Compute the strongly connected components of the dependency
graph.
Extract and schedule the component graph.
Initialize all signals to their initial value.
For each component c in the component graph {
For each time step t from 0 to last_time_step {
For each signal s in SCC c {
Compute the value of s for time step t;
Store the value of s at time step t in a signal history.
}
}
}

The first step is to produce a signal graph from from the simulation source code using a method such as [this patent, signal extraction]. A signal graph is a representation of the design such that there is a vertex for each signal and all assignments to a given signal are combined into a single assignment and annotated to the vertex in the signal graph corresponding to that signal. The use of a signal graph for out-of-order simulation is advantageous because it allows the simulation to process each individual signal across multiple time steps efficiently.

Next, a signal dependency graph is extracted from the signal graph. A signal dependency graph is a directed graph in which vertices represent signals and an edge (u,v) indicates that signal v depends on signal u, that is, an assignment for signal v reads the value of signal u. For example, given the assignment “sig_a=sig_b+1”, the dependency graph would contain vertices labeled “sig_a” and “sig_b” and there would be an edge from the vertex labeled “sig_b” to the vertex labeled “sig_a”.

Next, the strongly connected components (SCCs) of the dependency graph are computed. A directed graph, G=(V,E), is connected if for all pairs of vertices, u and v, either there is a path from u to v or a path from v to u. A strongly connected component (SCC) of a graph is a maximal set of vertices U⊂V such that for every pair of vertices u and v in U, there is a path from u to v and a path from v to u. As noted previously, computing SCCs use standard algorithms that are well known in the art.

The component graph of a graph, G=(V,E), is a directed acyclic graph, CG, in which there is a vertex representing each SCC of G and there is an edge (u,v) in CG if there are edges from any vertex in the SCC in G represented by vertex u to any vertex in the SCC in G represented by vertex v. A component graph has the property of being acyclic because, if there was a cycle in the component graph, it must be part of an SCC, but SCCs are represented by single vertices in the component graph. Therefore component graphs must be acyclic.

Since the component graph is acyclic, there is a defined ordering between vertices such that the vertex v is ordered after all vertices u for which the edge (u,v) exists. For simulation purposes, it is necessary to simulate signals after signals they depend on have been simulated. Simulating SCCs in the order defined by the component graph guarantees that signal values required for a particular signal will have been computed before they are needed.

The outer for loop iterates over SCCs in component graph order. The inner loop computes the value for each signal in the SCC for each time step. If the SCC consists of more than one signal, then the signal values for the SCC must be simulated in-order with respect to each other (although, they are simulated out-of-order with respect to signals in other SCCs). Signals within a SCC must be simulated in order because each signal is dependent on other signals in the SCC and each signal is dependent on itself. Computing the value of one of the signals in the SCC at time t cannot be done until the value of that signal has been computed at time t−1. However, since all other signals in the SCC are also functions of this signal, all other signal values cannot be computed for time t until the value for this signal has been computed for time t−1. Consequently, within a SCC, all signal values must be computed for a given time step before moving on to the next time step and, therefore, simulation within a SCC must be done in-order. Prior art methods can be used for performing the in-order simulation within a SCC, such as:
event-driven simulation.
Levelized, cycle-based simulation.

As an example out-of-order simulation, assume the design consists of an adder and the test performs a series of adds in successive time steps as shown in FIGS. 1A-1B and discussed hereinabove at paragraphs [00057]-[00070].

FIGS. 1C-1F illustrate the progress of out-of-order simulation for the example given in FIG. 1A. The first iteration of the outer loop selects signal “a” to be simulated. The values for “a” are generated by selecting a random value for “a” at each time step. FIG. 1C illustrates simulation progress after simulating signal “a”. The figure shows simulation for four time steps, labeled 0 to 3 in the figure. A vertical bar delineates each time step. The value for signal “a” is shown at each time step on the line labeled “a”. The other signal values, labeled “b”, “sum_out”, and “error” in FIG. 1c are shown with no values filled in for any time step indicating that these signals have not been simulated yet. FIG. 1d shows the results after simulating signal “b” for all time steps. The values for signal “b” are also generated randomly at each time step. The values for signal “b” are filled in as indicated on the line labeled “b”, indicating that signal “b” has completed simulation. The next step is to compute the value of “sum_out” for all time steps.

The value of “sum_out” is computed by adding the values of “a” and “b” for all time steps. In accordance with the present invention, this requires that signal value histories be stored after being computed so that signals that are part of succeeding SCCs can access them for computing other signal values out-of-order. In some embodiments, a technique such as is described in [this patent, compact representation] can be used to store signal value histories. FIG. 1e shows the results after completing this step of the simulation. The value of “a” and “b” are given on the lines labeled “a” and “b” respectively. The value of “sum_out” corresponding to the BDD that was computed by the symbolic simulation is given in the line labeled “sum_out”. For each time step, it can be seen that it is equal to the sum of “a” and “b” at that time step.

The next iteration of the outer loop computes the value of “error” for all time steps. The result of this step is shown in FIG. 1F which shows that the value of “error” is 0 for all time steps as expected on the line labeled “error” in the diagram. At this point, the value of all signals has been computed for all time steps so the simulation is complete.

This demonstrates that simulation can be performed in an out-of-order fashion in which some signal values are updated across time steps before other signals are. The total amount of computation required in out-of-order simulation is the same as in-order simulation in terms of the number of simulation events that must be processed. The advantage of out-of-order simulation is that allows optimizations to be performed that are not possible with conventional in-order simulators. In particular, out-of-order simulation allows:
Parallel simulation of signal values if a signal is dependent only on signals in other SCCs as exemplified by [this patent, binary to symbolic conversion].
Temporal optimization, in which a signal's function is unrolled across multiple time steps such that the amount of work to perform n time steps of simulation at a time is less than simulating the signal for n individual time steps as exemplfied by [this patent, reducing the time steps]. In particular, out-of-order simulation allows this optimization to be done on individual SCCs, which contain fewer signals than the entire design which, therefore, makes it easier to optimize.

Reducing the Number of Time Steps Requiring Simulation

Out-of-order simulation is a method of performing simulation whereby values for a given signal may be computed over multiple time steps before values for other signals are computed at some time step. A limitation of out-of-order simulation is that groups of signals that are sequentially dependent must be simulated in order. A sequentially dependent signal is one whose value in some time step is dependent on itself in some other time step, either directly, or indirectly by affecting the value of other signals which ultimately affect the value of the sequentially dependent signal. Consequently, none of the group of the signals can be updated in a time step without updating all other signals in the same time step, precluding the ability to perform out-of-order simulation on the group of signals.

During out-of-order simulation, other signals that are dependent on a sequentially dependent signal can be simulated out-of-order with respect to the sequentially dependent signal, but this requires that computed values for the sequentially dependent value be saved over all time steps. Therefore, it would be beneficial to have a method to simulate signals in-order given that the resulting values must be stored for all time steps. The present invention addresses these problems by performing optimization of the simulation across time steps and using the previously stored signal history information to perform simulation in parallel across time steps. Prior art simulation methods do not require the use of stored signal history values, only the values for the current time step. Therefore, prior art methods cannot address optimization across time or parallelization across time. The present invention allows optimizations of out-of-order simulation which have the benefit of improving simulation performance. Note that these improvements are not limited to out-of-order simulation and may also be used to improve performance of straight in-order simulation.

The simulation source code usually specifies how signals are updated at time step t using signal values at time t−1 (the previous time step), that is:. s(t)=f(s(t−1)). However, it is possible to use values at time t−2 or any other previous time offset, i.e. s(t)=f′(s(t−k)). Given s(t)=f(s(t−1)), for example, substituting the definition of s(t−1) into f(s(t−1)) yields a function of t−2:
Given s(t)=f(s(t−1)).
S(t−1)=f(s(t−1))[t←t−1] (substitute t−1 for t in the original expression)
S(t−1)=f(s(t−2))
S(t)=f(s(t−1))[s(t−1)←f(s(t−2))] (substitute (2) for s(t−1) in (1))
s(t)=f(f(s(t−2)))=f²(s(t−2))

For example, let s(t)=s(t−1)+1. Performing step 2 yields cnt(t−1)=cnt(t−2)+1. Performing step 3 by substituting cnt(t−2)+1 for cnt(t−1) yields cnt(t)=cnt(t−2)+2. This process is called unrolling a function. Note that, in this example, signal s is a function of itself, however, in general, it may be a function of other signals and may or may not be a function of itself. When a function is a function of itself and is unrolled for k steps, then the function, f in this case, will be applied to itself k times. As a shorthand, a superscript notation, f^{k}, is used to indicate the application of a function to itself k times.

Unrolling benefits simulation by allowing the simulation to skip time steps, reducing the total number of time steps that need to be simulated to get to a particular time step. For example, suppose the simulator has unrolled a function for 10 time steps. The simulator can compute the value at time 10 given the value of the signal at time 0 using this unrolled function. It can then compute the value at time 20 using the value for time 10 and so forth. Given an unrolled function, simulating for 100 time steps requires 10 signal updates instead of the 100 required using the original unrolled function. However, only the values at times 0, 10, 20, etc. would be available. If the value of the signal at some intermediate time step is needed, this is easily computed by simulating step-by-step from the closest computed time step. For example, to get the value for time step 95, the simulator can use a function, s(t)=f10(s(t−10)) to compute s at t=0,10,20,30 . . . 90 and then use the original definition, s(t)=f(s(t−1)) to compute s for t=91,92,93,94,95. The total number of evaluations is 14 instead of 95.

The amount of simulation effort is reduced if the amount of effort to simulate 10 steps at a time is less than ten times the effort to simulate one time step at a time. Generally, unrolling increases the size of the function for a given signal. However, the increase may be less if optimization of the unrolled expression is done. Such optimization is called temporal optimization. Prior art addresses optimization across signals using standard synthesis techniques such as redundancy removal, constant propagation, and strength reduction. However, these optimizations occur in a single time step of simulation. Since prior art methods do not unroll across time, there is no opportunity to optimize across time. In the method of the present invention, it is possible to apply standard optimization techniques across time in addition to across signals. To refine this, one aspect of the present invention used in at least some embodiments is to unroll across time and perform temporal optimizations of the resulting unrolled functions across time.

As an example of temporal optimization, the pipeline shown in FIG. 9A, signal “stg1” is unrolled over four cycles such that stg1(t)=f(stg1(t−4)). The resulting expression, as shown in FIG. 9F is “stg1(t)=stg1(t−4)”. This expression allows simulating four steps forward compared to one step forward in the original expression as given in FIG. 9B. However, the sizes of the expressions are the same, thus the temporally optimized version can simulate four cycles forward with the same amount of effort as the unrolled version resulting in improved simulation speed.

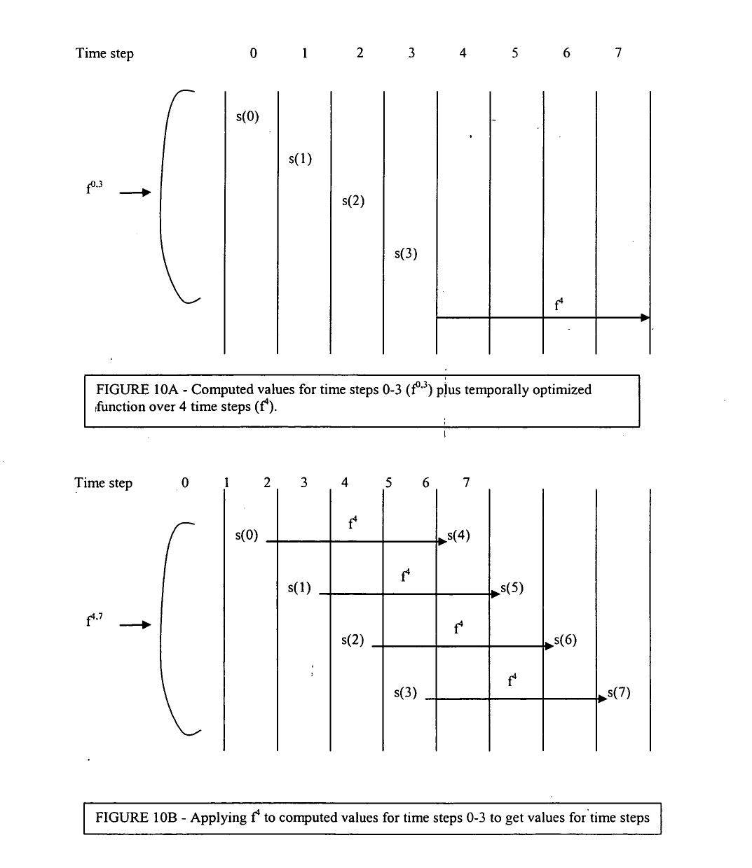

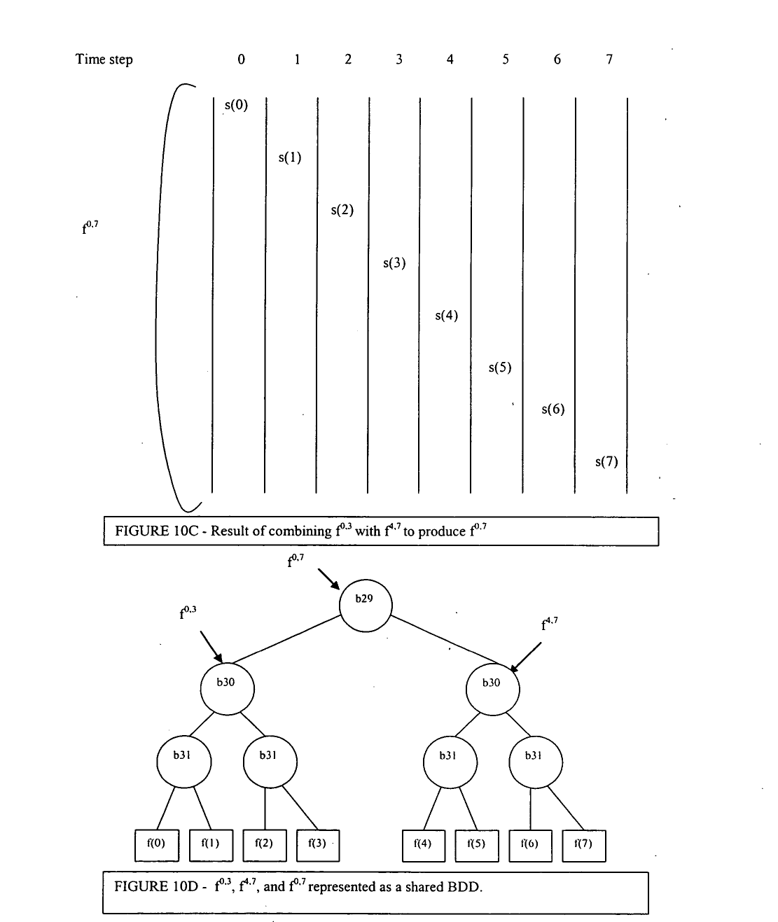

In out-of-order simulation, it is desirable to store the history of signal values for each time step after they are computed. In this case, it is possible to perform simulations of different time steps in parallel given a function which has been unrolled. Assume a sequentially dependent signal s(t)=f(s(t−1)) has been unrolled such that it is a function of t−4, s(t)=f⁴(s(t−4). Assume that the simulator has already computed the value of signal s for time steps 0-3 as illustrated in FIG. 10A. In this figure, each time step is delineated with a vertical line. The label, s(0), s(1), s(2), s(3), indicate the history values for signal s, computed at the appropriate time steps. These values could be represented internally using a BDD, for example. Given a value at time step t, substituting this value into function f⁴ gives the value at time t+4. For example, substitution of the value for time step 3 into f⁴ yields the value for time step 7, represented as the line labeled f⁴ in FIG. 10a. Performing this substitution for each time step from 0 to 3 results in the values for time steps 4 to 7 as illustrated in FIG. 10B. Combining the new values for times 4 to 7 with those from 0 to 3 means that values from 0 to 7 have been computed. The illustration shows that each application of f⁴ to each history value is independent. For example, s(4) can be computed from s(0) directly without having to compute s(1), s(2), or s(3). Thus, it can be done independently of computing other values. Each of the other time steps has the same property, and so, all values can be computed independently and in parallel.

In one embodiment, symbolic simulation can be used to perform this computation in parallel. The history of a signal is represented by the label fx,y where x and y are the start and end times, respectively, of the history. For example, FIGS. 10A-10C show the history of s for times 0-3, 4-7, and 0-7 respectively as indicated by labels f^{0,3}, f^{4,7}, and f^{0,7} respectively. Let f^{0,3} be represented by a BDD. Symbolically simulating the function f⁴ using the BDD labeled f^{0,3} as input will yield the BDD for f^{4,7} as illustrated in FIG. 10D. Creating a BDD representing values for times 0 to 7 is done by combining the two BDDs, f^{0,3} and f^{4,7}. This is done by determining the bit in the time bit vector which differentiates the existing computed time steps and the newly computed time steps. In this example, the time history ranges specified in history functions are restricted to being on boundaries that are powers of two. That is, for the existing function, the range must be 0 to 2^{k-1}−1 and the new function's range must be 2^{k-1} to 2^{k-1}. Assuming the time vector bits are labeled t₃₁-t₀ from highest to lowest order bit, then these functions will be functions of only the lowest order k bits of the time bit vector. The two BDDs are combined to create a time history function over the range 0 to 2^{k-1}. To do this, a single BDD node is created, labeled with time bit tₖ with its low outgoing edge point to the existing function for the range 0 to 2^{k-1}−1 and the high edge pointing to the function for range 2^{k-1} to 2^{k}−1.

For example, to combine functions f^{0,3} and f^{4,7} the algorithm first determines that k is 2, then creates a single BDD node (labeled f^{0,7}in FIG. 10C) labeled with t₂ with its low edge point to f^{0,3} and its high edge pointing to f^{4,7}.

Representing signal value histories using BDDs and using symbolic simulation to perform simulation in parallel over multiple time steps using unrolled functions beneficially improves simulation performance due to the potential of improved performance of symbolic simulation in performing multiple simulation steps in parallel.

As a further optimization, it is possible to use a technique called iterative squaring to perform the unrolling. The basic idea in iterative squaring is, given a signal with composed function s(t)=f^{k}(S(t−k)), the function s(t)=f^{2k}(s(t−2k)) can be computed by composing f(s(t−k)) with itself. This is done in two steps, first, given s(t)=f^{k}(s(t−k)), s(t−k)=f^{k}(S(t−2k)) is computed by substituting t=t−k for t in f^{k}(s(t−k)). The second step consists of substituting f^{k}(s(t−k)) for s(t−k) in f^{k}(s(t−k)) to get f^{2k}(s(t−2k)). This produces composed functions with lengths that are powers of two. Starting with f¹, which is the initial function defined by the simulation source program, iterative squaring produces f², f⁴, f⁸, etc. Using iterative squaring, it is possible to simulate to time t using no more than lg(t) (log to the base 2 t) simulation steps. In other words, with iterative squaring, the simulation starts with time 0, computes time 1, 2, 4, 8, 16, etc. up to desired time.

Iterative squaring can be used in conjunction with storing signal values across time. This reduces the number of simulation steps to be lg(K), where K is the total number of time steps to be simulated. The algorithm for doing this is as follows:
Let s(t)=f¹(s(t−1)) be the simulation function for s as given by the source code.
Let s(0), the initial value of the signal, be defined and known by the simulator.
Let K=2^{k}−1 be the maximum time to simulate.
Let t={tₖ₋₁,tₖ₋₂, . . . t₀) be the bit vector representing time.
Let f^{0,0}=s(0) be the initial value of the history function for signal s.
For i=0 . . . k−1
T=2ⁱ⁻¹ is the amount f was unrolled in the previous iteration of this algorithm. The current loop iteration will unroll for 2T time steps.

Time shift the previously unrolled function:
s(t−T)=f^{T}(s(t−2ⁱ))[t=t−T]=f^{T}(s(t−2T)).

Apply the time shifted unrolled function to history function:
f^{T,2T-1}=f^{T}(s(t−2T))[s(t−2T)=f^{0,T-1}].

Create the BDD representing f^{0,2T-1}:

f^{0,2T-1}=create_bdd(bdd_var(ti), f^{T,2T-1}, f^{0,T-1}), where bdd_var( ) returns the bdd variable index corresponding to time bit tᵢ.

End for.

Steps 1 to 4 are given from the simulation input. The basic loop computes both the signal history function and unrolls the signal definition function in parallel.

Initially, the history is set to the initial value at time 0 (line 5). The number of iterations is equal to the number of time bits in the time bit vector required to represent the maximum time to be simulated (line 3). For example, if the maximum time step is 4, then the time bit vector size is 2. Line 7 defines how many time steps the current iteration will unroll, which is double the amount of the previous iteration. Step 8 performs the unrolling using iterative squaring as described above. Steps 9 and 10 perform the simulation across multiple time steps in parallel as illustrated by FIG. 10 (described previously) to produce the signal values up to time T.

Iterative squaring-based unrolling combined with parallel evaluation using symbolic simulation is beneficial because it reduces the number of simulation steps to lg(K) where K is the total simulation time, which potentially gives an exponential speedup over prior art methods.

Improving Time-Ordered Simulation

Conventional time-ordered simulation can be improved by computing a minimal set of signals that need to be simulated and flattening these such that they are functions only of signals in the minimal set and performing signal-level optimization across the minimal set to share subexpressions and remove don't care logic. Standard time-ordered algorithms such as oblivious simulation and event-driven simulation can be performed over the minimal set.

It is also possible to do temporal optimization of time-ordered simulation either alone, or in conjunction with computing a minimal set. The simulation is still strictly time-ordered, but, instead of going from step t to step t+1, the simulator goes from step t to step t+k. This allows subexpression sharing and optimization to be done over time as well as over signals in time-ordered simulation.

Improving Waveform Dumping

Debugging simulation output is usually done by dumping waveforms which give the value of every signal for all time steps during the simulation. This data is normally stored in a file. In time-ordered simulation the simulator dumps the value of each signal at every time step if the signal value changes. This is a very time consuming process and can slow simulation dramatically. In addition, the waveform files are often very large. Therefore, there is a need to improve performance of dumping and to reduce dump database size.

In another aspect of at least some embodiments of the present invention, BDDs are used to represent waveform data. BDDs can be more compact than a discrete step-by-step list of values because of subexpression sharing. Furthermore, using a shared BDD structure allows subexpression sharing across signals in the waveform file, further compacting the data.

Also, a related aspect of at least some embodiments is that only the minimal set of signals need be dumped. Since the minimal set is a small fraction of the total number of signals, the file size is greatly reduced and dumping speed is increased since fewer signals are being dumped.

To reconstitute the full set of signals at some time step, the values of the minimal set at time t are loaded into the simulator. The simulator is then stepped forward for the appropriate number of time steps. For example, the pipeline shown in FIG. 9A has a minimal cut set consisting of signal “stg1” only. The waveform for this circuit will have only the values of signal “stg1” for all time steps. To get the value of “stg2”, for example, at time t, the value of “stg1” at time t−1 is loaded into the simulator and then one step of simulation is performed resulting in “stg2” having the correct value at time t.

Having fully described an embodiment of the invention including a number of aspects as well as numerous alternatives, those skilled in the art will recognize that other and further implementations and alternatives exist which are within the scope of the invention. As a result, the invention is not to be limited by the foregoing description, but only by the appended claims.

1. A method of developing a symbolic representation of a electronic device from a hardware description language representation of that device, wherein the hardware description language representation includes at least one event, comprising
establishing a plurality of signal assignments,
establishing at least one trigger to specify at which time steps an event occurs,
establishing an association between the at least one trigger and at least one of the plurality of signal assignments,
if the associated trigger is true at a given time step, applying to the signal the value computed by the at least one signal assignment associated with that trigger, and
if the associated trigger is not true at a given time step, allowing the signal to retain the current value.

2. The method of claim 1 wherein every signal assignment has an associated trigger.

3. The method of claim 1 further including combining multiple signal assignments by specifying a set of triggers in priority order.

4. The method of claim 3 wherein the multiple signal assignments may be affected by waits and delays.

5. The method of claim 4 wherein the multiple signal assignments affected by waits and delays may be combined into a single assignment.

6. A method of representing the operation of an electronic device in accordance with a hardware description language representation of that device comprising
establishing a plurality of vertices, where each vertex represents a signal,
annotating each vertex with a set of assignments to the signal, and
representing a dependency between two signals as an edge between the vertices associated with those signals.

7. The method of claim 6 further including the step of parsing the hardware description language representation into an event graph.

8. The method of claim 7 further including the step of scheduling the vertices of the event graph.

9. The method of claim 8 further including the step of annotating the event graph with a trigger function in accordance with semantics from the hardware description language representation.

10. The method of claim 9 further including the step of combining multiple assignments to the same vertex in accordance with semantics from the hardware description language representation.

11. A method for representing signal values as functions of time using binary decision diagrams comprising the steps of
representing time as a bit vector of a predetermined number of ordered bits,
establishing an ordered set of BDD variable indices,
associating the ordered set of BDD variable indices with selected ones of a plurality of vertices, and
mapping the ordered bits onto the ordered set of BDD variable indices, where the lower order indices appear above vertices with higher numbered indices.

12. A method for computing a minimal signal set capable of achieving a simulation comprising the steps of
creating an extracted signal graph from a hardware description language representation of a device,
establishing a plurality of vertices wherein each vertex represents a signal and a plurality of edges wherein each edge represents signals that are functions of other signals, and
computing relationships between strongly connected components of the plurality of vertices and edges.

13. A method for translating a conventional simulation into a symbolic simulation comprising the steps of
establishing a plurality of signal assignments,
establishing at least one trigger to specify at which time steps an event occurs,
establishing an association between the at least one trigger and at least one of the plurality of signal assignments,
setting the value of a signal in accordance with the value of the trigger at a given time step, and
calculating a minimal signal set for representing the operation of a device.

14. A method for performing signal ordered simulation of a device represented in a hardware description language comprising the steps of
computing signal dependencies specifying functional relationships among a plurality of signals,
computing strongly connected components from the signal dependencies,
computing a component graph for the signal dependencies,
processing a first strongly connected component in component graph order, and
simulating the signals in each strongly connected component for substantially all time steps before simulating any signals in the next-in-order strongly connected component.

15. The method of claim 14 further including establishing a minimal signal set for simulating the device.

16. The method of claim 14 further including unrolling across time a function which represents a signal.

17. The method of claim 16 wherein the unrolling reduces the number of time steps required to be simulated.

18. The method of claim 16 wherein the unrolling is iterative squaring-based.

19. The method of claim 14 further including the step of storing the history of signal values for each time step.

20. The method of claim 6 wherein the signals represent waveform data.

21. A system for developing a symbolic representation of a electronic device from a hardware description language representation of that device, wherein the hardware description language representation includes at least one event, comprising
a first storage area for storing a plurality of signal assignments,
a second storage area for storing at least one trigger to specify at which time steps an event occurs, and
processing means for associating the at least one trigger and at least one of the plurality of signal assignments, wherein the processing means applies to the signal the value computed by the at least one signal assignment associated with that trigger if the associated trigger is true at a given time step, and allows the signal to retain the current value if the associated trigger is not true at a given time step.
